(19) United States
(12) Patent Application Publication
(10) Pub. No.: US 2026/0291894 A1
(43) Pub. Date: Sep. 24, 2026

(54) SYSTEM

(71) Applicant: SoftBank Group Corp., Tokyo (JP)

(72) Inventor: Kota TANAKA, Tokyo (JP)

(73) Assignee: SoftBank Group Corp., Tokyo (JP)

(21) Appl. No.: 19/567,467

(22) Filed: Mar. 16, 2026

(30) Foreign Application Priority Data
Mar. 19, 2025 (JP) 2025-045264

(51) Int. Cl. H04L 51/02; G06N 3/0475

(52) U.S. Cl. CPC H04L 51/02; G06N 3/0475

(57) ABSTRACT

A system includes a processor that is configured to receive information via an input interface for receiving information from a user, analyze the received information and identify an emotion of the user by using natural language processing techniques, and generate a prompt for instructing a generative AI model to generate an appropriate response based on the identified emotion and attribute information of the user.

### CROSS-REFERENCE TO RELATED APPLICATION

This application is based on and claims priority under 35 USC 119 from Japanese Patent Application No. 2025-045264 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional dialogue systems and response generation systems that utilize generative AI models often generate responses solely on the basis of surface-level textual content provided by a user, without sufficiently considering the underlying emotional state of the user. As a result, the generated responses may be inappropriate in tone, may fail to match the user's current feelings, and may reduce user satisfaction or trust in the system. In addition, many existing systems do not flexibly adapt responses based on user attribute information such as age, gender, or other profile data, thereby limiting personalization and contextual suitability. Furthermore, in typical implementations, the construction of prompts for generative AI models is performed in a static or manually predefined manner, which makes it difficult to dynamically adjust the instructions given to the generative AI model according to the user's emotion and attributes in real time. Therefore, there is a need for a system that can automatically analyze user input to identify the user's emotion by using natural language processing techniques, and that can generate prompts for instructing a generative AI model to produce appropriate and personalized responses based on both the identified emotion and the user's attribute information.

### SUMMARY

To solve the above-described problems, a system according to one embodiment of the present invention comprises a processor, wherein the processor is configured to receive information via an input interface for receiving information from a user, analyze the received information and identify an emotion of the user by using natural language processing techniques, and generate a prompt for instructing a generative AI model to generate an appropriate response based on the identified emotion and attribute information of the user. The processor is further configured to transmit the generated prompt to the generative AI model and cause the generative AI model to generate the response, and to format the generated response and display the formatted response on an information display device. By automatically constructing prompts that reflect both the user's emotional state and the user's attribute information, and by supplying these prompts to a generative AI model, the system enables generation of responses whose tone, style, and content are more suitable for the user, thereby improving personalization, contextual appropriateness, and overall user experience.

The term “processor” refers to any hardware component or combination of hardware components, such as a central processing unit (CPU), a graphics processing unit (GPU), a digital signal processor (DSP), a microcontroller, or a circuitry including one or more of these elements, that is capable of executing instructions and performing logical and arithmetic operations to implement the functions described in the claims.

The term “input interface” refers to any hardware or software interface, or a combination thereof, that enables a user to provide information to the system, including but not limited to a graphical user interface, a keyboard, a mouse, a touch panel, a microphone, a camera, a communication interface for receiving data from an external device, or an application programming interface (API).

The term “user” refers to any human operator or entity that interacts with the system by providing information through the input interface and/or by viewing or utilizing the responses generated by the system.

The term “information from a user” refers to any data provided by the user through the input interface, including at least one of natural language text, voice input, image data, selection input via a graphical user interface, and metadata or profile information associated with the user.

The term “analyze the received information” refers to processing the information from the user to extract features, structures, or meanings, including but not limited to tokenization, part-of-speech tagging, syntactic parsing, semantic analysis, sentiment analysis, and classification of the information into one or more categories relevant to emotion identification or response generation.

The term “natural language processing techniques” refers to any computational methods or algorithms used to process and interpret human language, including but not limited to rule-based approaches, statistical models, machine learning models, and deep learning models, which perform operations such as tokenization, tagging, parsing, semantic analysis, sentiment analysis, and emotion detection.

The term “identify an emotion of the user” refers to determining one or more emotional states represented in or inferred from the information from the user, such as happiness, sadness, anger, fear, surprise, disgust, empathy, frustration, or any other affective state, and optionally assigning a label or a numerical score indicating the type and/or intensity of the emotion.

The term “attribute information of the user” refers to profile-related or contextual information associated with the user, including but not limited to age, gender, language preference, geographic location, cultural background, usage history, interaction history, application context, or device information, which may be used to personalize the generated response.

The term “prompt” refers to a textual or structured instruction, or a set of such instructions, generated by the processor and supplied as input to a generative AI model, the prompt specifying conditions, constraints, style, tone, or content requirements to guide the generative AI model in generating a response.

The term “generative AI model” refers to any machine learning model or artificial intelligence model that is configured to generate new content, including but not limited to text, based on input data and learned parameters, such as a neural network-based language model, a transformer model, or other generative models trained on large-scale data.

The term “appropriate response” refers to a response generated by the generative AI model that is determined, based on the identified emotion of the user and the attribute information of the user, to be suitable in at least one of content, tone, style, politeness level, empathy level, and contextual relevance for the user's situation or intent.

The term “transmit the generated prompt to the generative AI model” refers to providing the generated prompt, via a hardware or software communication path, to the generative AI model, whether the generative AI model is implemented in the same device as the processor or in a remote device connected through a network.

The term “format the generated response” refers to processing the response generated by the generative AI model to adapt it to a display or output requirement, including at least one of organizing the text structure, inserting line breaks, adding labels or metadata, converting character encoding, or transforming the response into a layout suitable for presentation on an information display device.

The term “information display device” refers to any device or component capable of visually or audibly presenting information to the user, including but not limited to a computer monitor, a smartphone screen, a tablet display, a wearable display, a television, a speaker system, or any combination thereof.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

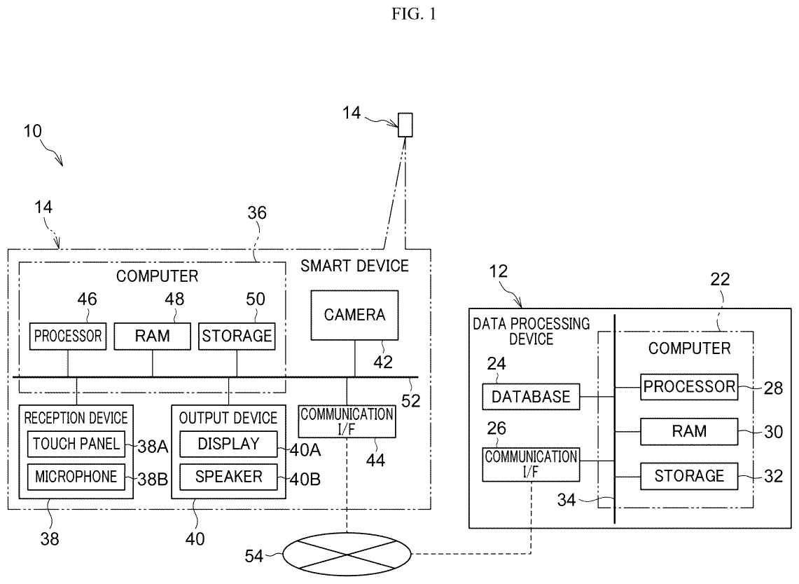

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

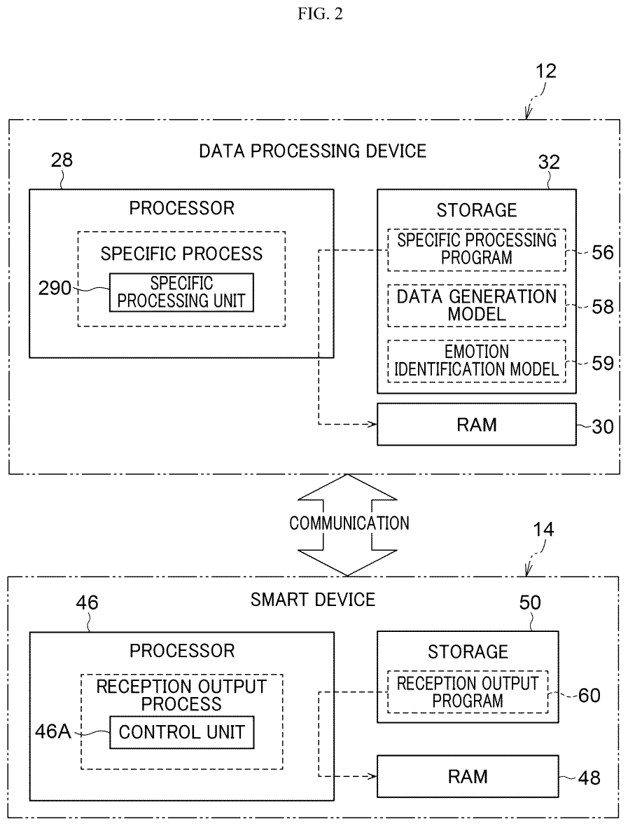

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented dialog systems that utilize a generative AI model typically accept user input in a simple, unstructured form and pass such input directly to the generative AI model. In such systems, the processing performed by a server is often limited to relaying text from a user terminal to the generative AI model and returning the model's text output to the terminal with minimal transformation. As a result, several technical problems arise in terms of computer technology.

First, when unstructured user input is directly supplied to a generative AI model without systematic structuring or normalization, the server is required to perform ad hoc preprocessing and postprocessing in application-specific code. This leads to increased processing complexity on the server side, inefficient use of processor and memory resources, and difficulty in scaling the system as the number of users or the diversity of input formats increases. Moreover, because the prompt sentence supplied to the generative AI model is not generated according to a consistent data representation scheme, it is difficult to guarantee stable response quality and reproducibility across different executions.

Second, conventional systems do not effectively exploit structured representations of user attribute information and user-specified keywords. Attribute information such as generation, gender, or other profile data and user-selected keywords are often handled as plain text, without being converted into a structured data format prior to prompt generation. Consequently, the server cannot systematically control how such attribute information is reflected in the prompt sentence, which can lead to suboptimal personalization, inconsistent responses, and unnecessary consumption of computational resources by the generative AI model.

Third, in many existing architectures, the formatting of response information into a form suitable for display on a user terminal is implemented by scattered, non-standard transformation logic. HTML or other markup and client-side scripting are often assembled in an ad hoc manner, which causes redundant rendering operations, inefficient data transfer, and inflexibility when adapting the user interface to different device environments. In particular, systems that do not clearly separate data-level response information from standardized description formats and dynamic display description formats may suffer from increased processing load on both the server and the client, degraded responsiveness, and difficulty in maintaining or extending the code base.

Therefore, there is a need for an improved computer-implemented system and server-side processing technique that (i) converts user input, including attribute information and keywords, into a structured data format, (ii) generates a prompt sentence for a generative AI model on the basis of such structured data, and (iii) systematically formats AI-generated response information into standardized and dynamic display description formats. Such a system should improve the efficiency, scalability, and consistency of the end-to-end processing pipeline, and thereby improve the overall operation of the computer system, including the server and user terminal, rather than merely automating a manual procedure.

The specific processing by the specific processing unit 290 of the data processing device 12 in Example 1 is realized by the following means.

The present invention provides a server comprising a processor configured to receive, via a communication network and from a user operation apparatus, information including attribute information of a user and a keyword; analyze the received information and convert the received information into a structured data format; generate, on the basis of the structured data format, a prompt sentence including an instruction for generation to a generative information processing model; generate a request message for transmitting the prompt sentence to the generative information processing model and transmit the request message to the generative information processing model via the communication network; receive, from the generative information processing model, response information generated on the basis of the prompt sentence; format the received response information into display data that is displayable on the user operation apparatus by using a standardized description format and a dynamic display description format; and transmit the display data to an information display apparatus. This enables the server to transform unstructured user input into a structured representation, to generate consistent and attribute-aware prompt sentences for the generative AI model, and to systematically convert AI-generated response information into standardized and dynamic display formats, thereby improving the efficiency, scalability, and responsiveness of the overall computer system.

The term “user operation apparatus” refers to an electronic apparatus operated by a user, including at least an input unit and a communication unit, and configured to transmit user input information to a server and to receive and present display data, such as a terminal device executing a web browser or an application program.

The term “attribute information” refers to information indicating characteristics of a user, including but not limited to demographic information, preference information, profile information, or other user-related parameters, which are used to personalize processing by a server or a generative AI model.

The term “keyword” refers to a word, phrase, or symbolic expression designated by a user or a system, which represents a topic, theme, or concept to be emphasized or considered in the generation of content by a generative AI model.

The term “communication network” refers to a wired or wireless data communication infrastructure, including but not limited to the internet, local area networks, or mobile communication networks, which enables data exchange between a server, a user operation apparatus, and external services.

The term “structured data format” refers to a data representation format in which data elements are organized according to a predefined schema or structure, such as a hierarchical or relational format, enabling systematic parsing, processing, and transmission by a computer system.

The term “hierarchical data representation format” refers to a structured data format in which data elements are arranged in a parent-child relationship forming a tree or nested structure, such as a markup-based or key-value-based hierarchical representation.

The term “prompt sentence” refers to a natural-language or semi-structured text sequence that encodes an instruction, context, or constraint to be supplied as input to a generative AI model for controlling or guiding generation of response information.

The term “instruction for generation” refers to a part of a prompt sentence or control data that explicitly or implicitly specifies a generation objective, style, content scope, or behavior to be executed by a generative AI model.

The term “generative information processing model” refers to a trained computational model, such as a generative AI model or large-scale neural network, configured to generate text, image, audio, or other data as output in response to input data including a prompt sentence.

The term “request message” refers to a data structure or communication unit transmitted from a server to a generative information processing model, typically via an application programming interface, and including at least a prompt sentence and optional parameters controlling generation.

The term “response information” refers to data generated by a generative information processing model in response to a request message, including at least a generated text sequence and optionally associated metadata such as scores or classification labels.

The term “standardized description format” refers to a document or data markup format defined by a standard specification, such as a text-based markup language, that describes a document structure or layout to be interpreted by an information display apparatus.

The term “dynamic display description format” refers to a description format including executable or interpretable instructions, such as script code or event-driven definitions, which enables a user operation apparatus to dynamically modify or update a displayed content.

The term “display data” refers to data obtained by formatting response information into a representation that is interpretable by an information display apparatus and that specifies at least a document structure and optional dynamic behavior for presentation on a user interface.

The term “information display apparatus” refers to a device or component, such as a display unit or screen of a user operation apparatus, capable of receiving display data and visually presenting corresponding content to a user.

The term “processor” refers to a hardware or hardware-implemented processing unit, such as a central processing unit or other computation engine, configured to execute instructions for performing the receiving, analyzing, converting, generating, transmitting, and formatting functions described in the system.

The term “script execution environment” refers to a software runtime environment or interpreter configured to execute scripts written in a high-level language, and to perform data analysis, conversion into a structured data format, and generation of prompt sentences on a general-purpose information processing apparatus.

The term “general-purpose information processing apparatus” refers to a computing apparatus including at least a processor, a memory, and an input/output interface, and configured to execute various software programs not limited to a single dedicated function.

In one embodiment, a server cooperates with a terminal operated by a user to implement a system that generates personalized response information using a generative AI model on the basis of structured user input. The server includes at least one processor, a memory, a non-transitory storage medium storing program instructions, and a network interface. The terminal includes at least a display, an input unit, a browser or application execution environment, and a communication interface.

The server executes a server program on the processor. The server program is implemented, for example, using a general-purpose scripting language runtime such as a Python execution environment running on a central processing unit. The server program runs under a web application framework such as a generic web framework and communicates with a web server component via a standard gateway interface. The server also communicates with an external generative AI model through an application programming interface over a packet-switched communication network.

The terminal executes a browser or a dedicated application program on a processor such as a mobile processor or a general-purpose central processing unit. The terminal renders a user interface that includes input elements for receiving attribute information of the user, including, for example, generation, gender, and other profile items, as well as at least one keyword representing a concept or topic of interest. The terminal uses a standardized document description format, such as a markup language, and a dynamic display description format, such as a client-side scripting language, to render and update the user interface on the display.

The user operates the terminal to access a network address of the server and to enter attribute information and at least one keyword into an input form. The terminal transmits, over the communication network, the entered information as request data to the server. The transmitted data includes at least character string values corresponding to the attribute information and the keyword.

The server receives the request data via the network interface. The server uses the processor to parse the request data and to map the received character strings into an internal structured data representation. In one embodiment, the server constructs a hierarchical data structure, such as a tree of key-value pairs, in a structured data format. The server stores this hierarchical structure in the memory. The server uses a script execution environment to implement this mapping and structuring, and to ensure that each user attribute and keyword is assigned to a specific field in the hierarchical representation.

The server applies validation and normalization rules to the structured data. The server normalizes, for example, generation information into a standardized representation, converts gender information into a predefined category, and sanitizes the keyword to remove undesired control characters. The server thereby reduces the variability of input patterns and prepares a consistent representation that can be deterministically converted into a prompt sentence.

The server generates a prompt sentence based on the structured data. The server reads the hierarchical data structure from the memory and assembles a natural-language text that embeds the attribute information and the keyword in predetermined positions. The server determines the sentence template based on the presence or absence of particular attributes and may select between multiple templates stored in the storage medium. In one embodiment, the server generates a prompt sentence such as:

“The user is a woman born in the 1990s. Considering that she wants to focus on the keyword ‘future’, please generate personalized word suggestions and short messages that resonate with her generation and gender.”

In another example, when the user is a man born in the 2000s and the keyword is “challenge”, the server generates a prompt sentence such as:

“The user is a man born in the 2000s who has selected the keyword ‘challenge’. Please output several inspiring phrases and short messages that match his age group and emphasize the idea of ‘challenge’.”

By generating the prompt sentence from the structured data in a rule-based manner, the server enforces consistent inclusion and ordering of relevant information and ensures that a generative AI model receives prompts that are both syntactically coherent and semantically aligned with the attribute information.

The server transmits the generated prompt sentence to a generative information processing model. The generative information processing model is implemented, in one embodiment, as a large-scale neural network architecture such as a transformer-type generative AI model. The generative AI model includes multiple layers of self-attention modules and feedforward layers, and is configured to perform auto-regressive generation of token sequences. The generative AI model is deployed on a computing platform that includes at least one graphics processing unit or other parallel processing accelerator and that exposes an application programming interface. The server packages the prompt sentence, together with parameters such as temperature, maximum token count, and decoding strategy, into a request message formatted as a structured message for the application programming interface.

The generative AI model has been trained using a supervised or semi-supervised learning method on a large corpus of natural-language text. During training, the generative AI model updates internal weight parameters by minimizing a loss function such as cross-entropy loss between predicted tokens and ground-truth tokens. The training process uses gradient-based optimization, such as stochastic gradient descent or a variant thereof, and updates the model's weight parameters according to backpropagation. The generative AI model may employ data augmentation techniques, such as random masking or shuffling of training sequences, to improve generalization. The server, however, need not perform training; instead, the server utilizes an already trained model for inference.

During inference, the generative AI model receives the prompt sentence, converts it into token identifiers through a tokenizer, and processes the token sequence through the transformer layers. Each layer performs attention weight computation based on query, key, and value vectors, followed by linear transformations and non-linear activation functions. The generative AI model computes, for each position in the output sequence, a probability distribution over possible next tokens, and selects tokens according to a decoding algorithm such as greedy decoding or probabilistic sampling governed by the temperature parameter. This token-level operation is executed on vectorized data structures and matrix multiplications, which exploit the parallelism of the underlying hardware accelerators.

The server receives, as response information, a generated text sequence from the generative AI model through the application programming interface. The server parses the response message, extracts the generated text, and stores it temporarily in the memory. The server may perform additional processing on the generated text, such as trimming leading and trailing whitespace, removing disallowed terms based on a prohibited-word list, or segmenting sentences according to punctuation. By implementing these steps in the server environment, the system ensures that the text is normalized and safely presentable to the user.

The server formats the response information into display data suitable for rendering on the terminal. The server applies a standardized description format, such as a markup language defining document structure, and a dynamic display description format, such as a client-side scripting language, to embed the response information into a coherent user interface layout. In one embodiment, the server embeds the generated text within paragraph elements, list elements, or card components defined in the markup language, and associates event handlers defined in the scripting language with interactive elements such as buttons for requesting alternative suggestions or copying text to the clipboard. The server constructs a document structure that separates presentation from content, and thereby allows the terminal to render and update specific regions of the interface without reloading the entire document. The terminal receives the display data from the server and uses the browser or application rendering engine to interpret the standardized description format and execute the dynamic display description format. The terminal constructs a document object model from the markup and attaches the scripting functions to associated nodes. The terminal displays the generated response text in a designated area of the screen, such as a result panel, and updates the layout based on user actions or script-driven animations. The terminal may scroll the view to the generated response, highlight certain keywords, or show multiple candidate messages in separate components.

The server thereby improves the efficiency and technical performance of the system compared to conventional configurations. Because the server converts user input into a structured data format before generating the prompt sentence, the server can reuse the same data representation across different requests and enforce deterministic transformations. This reduces the amount of ad hoc parsing logic, lowers the possibility of parsing errors, and allows for more efficient caching strategies. The server can, for example, detect repeated attribute patterns and reuse existing prompt templates, reducing CPU utilization and memory allocations.

Moreover, by generating the prompt sentence according to a fixed template set and hierarchical attribute mapping, the server reduces variability in prompt construction and, consequently, variance in generative AI model responses. This leads to more predictable token distributions inside the neural network, decreasing the likelihood of generating irrelevant or malformed content. The improved stability of prompts contributes to more stable computational loads at the generative AI model side, enabling more predictable memory usage and inference times on the accelerator hardware.

The server's use of a standardized description format and a dynamic display description format also provides technical advantages. By separating the data-level response information from the presentation logic, the server can minimize the volume of transferred data when updating only a portion of the user interface. The server can, for instance, transmit only the newly generated response section rather than a complete page whenever a new prompt is processed. This reduces communication overhead on the network, lowers latency perceived by the user, and decreases energy consumption on the terminal due to reduced rendering work.

The server and terminal together implement processing flows that are not a mere automation of human mental steps. The server performs structured data construction, rule-based prompt generation, and format conversion using algorithmic rules that operate on data structures and that are optimized for machine execution. The generative AI model internally applies mathematical transformations on high-dimensional vectors, which are not accessible as human reasoning steps and which rely on trained weight matrices and attention mechanisms. The system therefore implements machine-specific techniques for data representation and processing that improve computer technology itself.

In another embodiment, the server uses alternative structured data formats, such as a graph-based representation or a relational table representation, instead of a hierarchical format. In such a case, the server defines mapping rules that convert between the chosen representation and the prompt sentence. The generative AI model may also be replaced by another type of generative information processing model, such as a sequence-to-sequence neural network with recurrent layers or a diffusion-based text generator, provided that the model accepts a prompt sentence as input and outputs response information as a token sequence or an equivalent structure.

In a further embodiment, the server includes a module that adjusts model parameters or selection policies for the generative AI model based on usage statistics. The server can, for example, modify temperature or maximum token parameters according to the length of the keyword or the number of attributes supplied. By controlling these parameters, the server can trade off generation diversity and latency to match resource constraints or target device capabilities. This contributes to optimized hardware utilization in environments with limited processing power or bandwidth.

The server may also implement a caching mechanism that stores mappings from specific structured data patterns to previously generated response information. When the same attribute combination and keyword appear, the server can skip requesting new generation from the generative AI model and instead reuse cached response information. This reduces the number of calls to the generative AI model, decreasing computational load on the accelerator hardware and reducing network round trips, thereby improving overall system throughput.

Through these configurations and variations, the server, the terminal, and the generative AI model cooperate to realize a technical solution in which structured data management, controlled prompt generation, and standardized response formatting collectively improve processing speed, response stability, communication efficiency, and resource utilization of the computer system, while enabling personalized content generation that would not be achievable through simple manual operations or direct, unstructured interaction with a generative AI model.

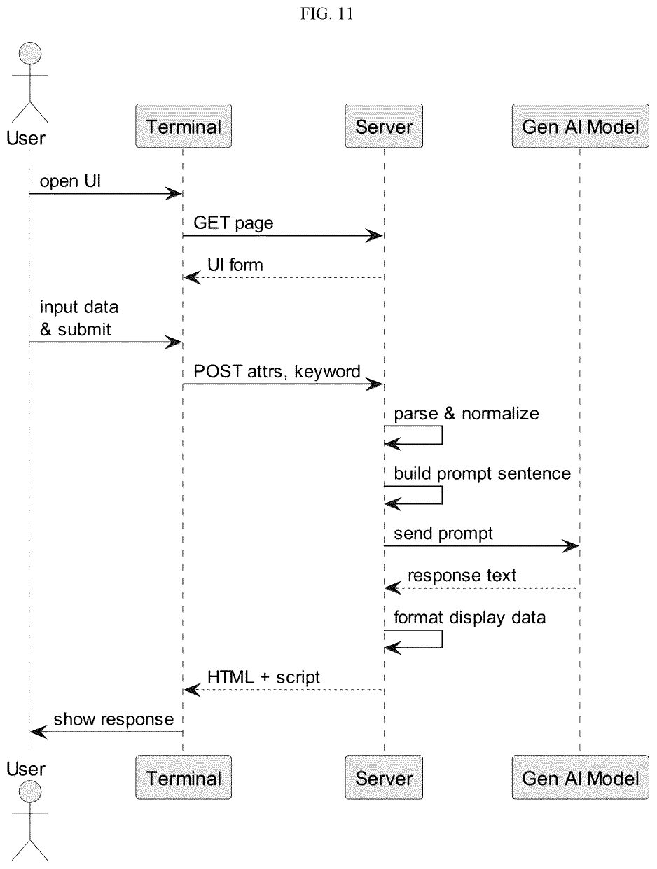

The following describes the processing flow using FIG. 11.

### Step 1

The user operates the terminal to access a network address of the server and to open an input screen. The input to this step is a user action such as entering a uniform resource locator or activating an application icon. The terminal sends a request message to the server and receives a document described in a standardized description format that defines input fields for attribute information and a keyword. The terminal parses the received document, constructs an internal document object model, and renders the input elements on the display as editable fields and buttons.

### Step 2

The user operates the terminal to input attribute information and at least one keyword into the displayed fields. The input to this step is user-generated character string data corresponding to, for example, generation, gender, and a keyword. The terminal gathers the values from the input elements when the user activates a submission control, packages the values into a request body according to a predefined parameter schema, and sends the request body as part of a network message to the server. The output from this step is structured request data transmitted over a communication network from the terminal to the server.

### Step 3

The server receives the request data from the terminal through a network interface. The input to this step is the network message containing the attribute information and the keyword as character strings. The server invokes a web application component that parses protocol headers and decodes the request body to extract parameter values. The server maps each extracted value to a corresponding internal variable and stores the variables in a temporary memory area. The output from this step is a set of in-memory variables representing the user's generation, gender, and keyword in an unstructured textual form.

### Step 4

The server converts the unstructured variables into a structured data format. The input to this step is the set of in-memory variables for the attribute information and the keyword. The server creates a hierarchical data structure, such as a tree of key-value pairs, and assigns each variable to a specific key in the structure. The server performs normalization operations, including trimming whitespace, converting character encodings to a canonical form, and mapping free-form inputs to standardized category labels where applicable. The server then serializes the hierarchical data structure into a structured representation format and stores it in memory. The output from this step is normalized structured data that encodes the user attributes and keyword in a deterministic schema.

### Step 5

The server generates a prompt sentence based on the normalized structured data. The input to this step is the hierarchical representation of the user's attribute information and keyword. The server selects a sentence template from a template set according to which attribute fields are present and which categories they belong to. The server performs string substitution operations to insert the normalized values into placeholder positions within the template. The server may apply additional rules, such as adding explanatory phrases or constraints on style and length, to form a complete instruction text. For example, the server generates a prompt sentence such as: “The user is a woman born in the 1990s. Considering that she wants to focus on the keyword ‘future’, please generate personalized word suggestions and short messages that resonate with her generation and gender.” The output from this step is a complete prompt sentence encoded as a character string.

### Step 6

The server prepares a request message for a generative AI model using the prompt sentence. The input to this step is the prompt sentence and optional generation parameters, such as maximum token length and temperature. The server constructs a message body in a structured message format, places the prompt sentence into a designated field, and inserts the parameter values into control fields. The server then adds protocol headers required by the external model interface, including authentication information and content type. The output from this step is a formatted request message ready for transmission to the generative AI model.

### Step 7

The server transmits the request message to the generative AI model and receives response information. The input to this step is the formatted request message containing the prompt sentence. The server sends the message over the communication network to an endpoint associated with the generative AI model. The generative AI model processes the prompt sentence using an internal neural network architecture, generates a token sequence as a response, and returns the result in a response message. The server receives this response message through the network interface, verifies status codes, and extracts the generated token sequence as text. The output from this step is a generated response text stored in the server's memory.

### Step 8

The server post-processes the generated response text. The input to this step is the raw generated text obtained from the generative AI model. The server performs cleaning and formatting operations, including removing leading and trailing whitespace, standardizing line breaks, and filtering out tokens that match a prohibited pattern list. The server may segment the text into logical units, such as separate suggestions or messages, by detecting sentence boundaries. The output from this step is a sanitized and segmented response text suitable for insertion into a user interface.

### Step 9

The server formats the response text into display data using standardized and dynamic description formats. The input to this step is the sanitized response text and a presentation template. The server embeds the response text into predefined regions of a document described in the standardized description format, such as placing each suggestion into a list element or a card component. The server also inserts dynamic display description code, such as script-based functions and event handlers, that control behaviors such as expanding or collapsing sections, copying a phrase to a clipboard, or requesting alternative responses. The server assembles these elements into a single document structure and sets metadata for character encoding and layout. The output from this step is display data that includes both structural markup and dynamic behavior definitions.

### Step 10

The server transmits the display data to the terminal. The input to this step is the fully assembled document containing the response information and associated dynamic display logic. The server writes protocol headers indicating the document type and encoding, attaches the document as the message body, and sends the message over the communication network to the terminal address that initiated the request. The output from this step is a network message containing the display data delivered to the terminal.

### Step 11

The terminal receives and renders the display data for the user. The input to this step is the network message carrying the formatted document. The terminal decodes the message, parses the standardized description format into a document object model, and executes the dynamic display description code using a script engine. The terminal draws visual components, such as text blocks and interactive buttons, on the display based on the parsed structure, and binds user interface events to the scripted behavior. The output from this step is a rendered user interface in which the generative AI model's response appears as readable text and interactive elements, allowing the user to view and further interact with the generated suggestions.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content delivery systems that utilize generative AI models typically accept a fixed prompt, forward the prompt to a remote inference engine, and return the generated content to a user terminal. Such systems are often implemented as simple request-response pipelines that do not deeply integrate user attribute information, emotional context, or user interaction history into the construction of prompts. As a result, these systems exhibit several technical shortcomings from the perspective of computer technology.

First, existing systems generally lack a structured mechanism in the server-side processing pipeline to normalize heterogeneous user attribute data (for example, free-form age, gender, and interest inputs) into standardized category information prior to prompt construction. Without such normalization, server-side components cannot systematically adapt prompt sentences to different user segments, and server resources are inefficiently used because similar prompts are redundantly generated or misaligned with user profiles.

Second, many systems do not perform integrated natural language processing on free-description user inputs to detect user emotion as a separate, machine-usable signal. The absence of an emotion-identification step in the server workflow limits the ability of the server to condition prompt sentences on the emotional context of the user, which leads to generic or inappropriate responses and inefficient utilization of generative AI model computation.

Third, typical architectures do not provide a feedback loop in which the server correlates each generated prompt sentence with fine-grained user behavioral signals, such as viewing time, preference operations, and explicit regeneration requests. Because this correspondence is not recorded and analyzed within the server, the server cannot update prompt generation conditions in a data-driven manner. Consequently, the system cannot automatically tune output format, length, style, or structure parameters over time, leading to suboptimal model calls, unnecessary regenerations, and increased network and processing load.

Fourth, content safety or policy compliance is often implemented as a separate, external filter that runs after generation, with no tight coupling to prompt generation and model-parameter control. When unsafe or non-compliant content is detected, typical systems simply block the output or perform shallow redaction, rather than programmatically altering prompt content or generation settings and re-executing model inference. This results in repeated manual intervention, wasted compute cycles, and degraded responsiveness of the system.

Accordingly, there is a need for an improved computer-implemented system and server-side control method that (i) acquires and normalizes user attribute information and free-description information, (ii) identifies user emotion using natural language processing, (iii) constructs prompt sentences including explicit control conditions for a generative AI model, (iv) maintains a feedback loop based on user interaction histories to adapt prompt-generation conditions, and (v) performs safety-aware post-processing that can trigger automatic prompt and model adjustments. Such a system should enhance the efficiency, adaptability, and reliability of generative AI-based content delivery as a whole, thereby improving the functioning of the computer system that manages prompt construction, model invocation, and content presentation.

The specific processing by the specific processing unit 290 of the data processing device 12 in Application Example 1 is realized by the following means.

The present invention provides a server comprising a processor and a memory storing instructions that, when executed by the processor, cause the server to generate, for display on an information terminal, a user interface screen for receiving user attribute information and free-description information, acquire the attribute information and the free-description information from the information terminal via a communication network, perform information processing including natural language processing on the acquired information to identify an emotion of the user from the free-description information and to normalize the attribute information into category information indicating at least a generation, a gender, and an interest field of the user, generate, based on the identified emotion and the normalized attribute information, a prompt sentence including conditions regarding at least an output format, an amount of content, a writing style, and a structure, construct instruction information that uses the prompt sentence as input to a generative AI model, transmit the prompt sentence and the instruction information to the generative AI model to cause the generative AI model to execute content generation processing and return generated content, perform post-processing on the generated content including at least formatting, structuring, adding metadata, and inspecting the generated content against predefined safety criteria or constraint conditions, when a violation is detected, modify at least one of the prompt sentence and generation conditions of the generative AI model and cause the generative AI model to regenerate content, generate display content converted into a display format corresponding to the attribute information of the user, transmit the display content to the information terminal for visual presentation, and acquire and record a viewing history and an operation history of the user with respect to the display content in association with the prompt sentence, and statistically analyze the recorded history to update generation conditions for subsequent prompt sentences. This enables the computer system to dynamically optimize prompt construction, model invocation parameters, and content formatting based on standardized user attributes, emotional context, and interaction feedback, thereby improving the technical efficiency, adaptability, and safety of generative AI-driven content delivery in a networked environment.

The term “processor” refers to a hardware-based information processing unit, such as a central processing unit or a logic circuit arrangement, that executes machine-readable instructions to perform arithmetic operations, control operations, and data transfer operations.

The term “memory” refers to a hardware-based storage device, such as a semiconductor memory or a non-volatile storage medium, that stores machine-readable instructions and data for access and execution by the processor.

The term “information terminal” refers to an electronic device having at least a display unit, an input unit, and a communication interface, such as a mobile device, a tablet device, a portable computer, or a stationary computer, that exchanges data with a server via a communication network.

The term “communication network” refers to an interconnection system, such as a wired network, a wireless network, or a combination thereof, that enables data transfer between the server and one or more information terminals using a communication protocol.

The term “user attribute information” refers to data representing characteristics of a user, including at least an age-related category, a gender category, and one or more interest-related categories, which are usable by the processor for personalization of content.

The term “free-description information” refers to text or text-equivalent data supplied by the user in a non-structured or semi-structured form, which is not constrained to predefined options and is subject to natural language processing by the processor.

The term “natural language processing” refers to a set of algorithmic techniques executed by the processor for analyzing and interpreting human language text, including at least tokenization, syntactic or semantic analysis, and extraction of features such as sentiment or emotion.

The term “emotion of the user” refers to an emotional state inferred from the free-description information using natural language processing, such as happiness, sadness, anxiety, or satisfaction, which is represented in a machine-usable form.

The term “category information” refers to normalized and discretized data indicating categorized values of user attributes, including at least a generation label, a gender label, and one or more interest labels, generated by the processor from heterogeneous user attribute information.

The term “prompt sentence” refers to a text string or text-equivalent data constructed by the processor, which encodes instructions, conditions, or context for a generative AI model to generate content.

The term “generative AI model” refers to a machine-learned information processing model, such as a neural network-based language model, that receives a prompt sentence as input and generates content by probabilistic inference or related generative computation.

The term “instruction information” refers to control data generated by the processor that specifies how the generative AI model is to be executed, including at least the prompt sentence and optionally generation parameters such as length, style, or structure constraints.

The term “content generation processing” refers to a sequence of computational operations performed by the generative AI model, in response to the prompt sentence and the instruction information, to produce machine-generated content such as textual content.

The term “generated content” refers to output data produced by the generative AI model as a result of content generation processing, including at least text data and optionally associated metadata.

The term “post-processing” refers to processing operations performed by the processor after receipt of the generated content, including at least formatting, structuring, addition of metadata, and optional inspection for safety or compliance.

The term “metadata” refers to auxiliary information associated with the generated content, such as tags, topic labels, timestamps, length indicators, or content-type identifiers, which assist in management, presentation, or retrieval of the content.

The term “display content” refers to content data after post-processing that has been converted by the processor into a format suitable for presentation on a display device of the information terminal, taking into account at least the user attribute information.

The term “display device” refers to a hardware unit, such as a liquid crystal display or an organic light-emitting display, included in the information terminal and configured to visually present the display content to the user.

The term “viewing history” refers to information indicating how the user has viewed the display content, including at least access times, viewing duration, or page traversal information, which is recorded by the processor.

The term “operation history” refers to information indicating interactive operations performed by the user with respect to the display content, including at least explicit preference operations, regeneration requests, or selection actions, which is recorded by the processor.

The term “predefined safety criteria” refers to rules or conditions stored in the memory and used by the processor to judge whether the generated content includes prohibited, harmful, or otherwise undesired elements.

The term “constraint conditions” refers to conditions defined in advance that limit or govern properties of the generated content, such as topic boundaries, stylistic restrictions, or allowed categories of information.

The term “behavioral information” refers to data derived from the viewing history and the operation history of the user, including at least viewing time, preference operations, and regeneration requests, which is used by the processor for statistical analysis.

The term “generation conditions” refers to parameters and constraints used by the processor when generating a prompt sentence and when instructing the generative AI model, including at least output format, amount of content, writing style, and structure settings.

The term “content regeneration processing” refers to content generation processing that is executed again by the generative AI model after modification of at least one of the prompt sentence and the generation conditions, typically in response to detection of a violation of safety criteria or constraint conditions.

The term “statistical analysis” refers to computational processing performed by the processor on recorded data, including at least aggregation, distribution analysis, or correlation analysis, to derive adjustments for the generation conditions.

In one embodiment, a server, one or more terminals, and one or more users cooperate to implement the present invention. The server includes at least one processor, a memory, a non-transitory storage device, a network interface, and a server-side display or console. The terminal includes at least one processor, a memory, a display device such as a liquid crystal display or an organic light-emitting display, a user input device such as a touch panel or keyboard, and a communication interface supporting wired or wireless communication.

The server executes server-side software implemented as an application program running on an operating system. The server runs, for example, a web application framework, a database management system, and a generative AI model execution environment. The server uses a database system to store user attribute information, free-description information, generated content, and interaction histories. The server uses a natural language processing library to perform tokenization, part-of-speech tagging, sentiment or emotion classification, and other text analytics on free-description information.

The terminal executes a browser or a native application that renders a graphical user interface for the user. The terminal uses its processor and graphics subsystem to display user interface elements such as input fields, buttons, and content viewing areas. The terminal uses its communication interface to exchange data packets with the server over a communication network such as the Internet, employing, for example, transport layer protocols and secure communication protocols.

The user operates the terminal to access a web application or native application provided by the server. The user views a screen on the terminal that includes input areas for entering attribute information, such as age-related information, gender-related information, and interest-related information, and for entering free-description information in natural language. The user touches or clicks input elements and enters text using the terminal's input device. The server stores application instructions in the memory. The server, by executing these instructions, generates a user interface definition that describes elements such as text fields for “generation,” “gender,” and “interests,” as well as a text area for free-description information. The server sends corresponding markup and script data to the terminal via the network interface. The terminal receives the data and renders the interface on the display device.

The server uses a data structure, such as a structured record with predefined fields for age category, gender category, and interest categories, to represent user attribute information. The server uses another data structure, such as a text buffer or character array, to represent free-description information. The server normalizes heterogeneous inputs by mapping raw user inputs to standardized labels. For example, the server maps numeric age “23” to a generation label “20s,” maps free-form gender labels such as “female,” “woman,” or “F” to a normalized gender label “female,” and separates an interest string such as “AI, smartphones, gadgets” into a list of interest tokens.

The server employs a natural language processing module, implemented using a statistical or neural classification model, to process the free-description information. The server tokenizes the input text into token sequences, computes embeddings or feature vectors for each token and for the entire text, and applies an emotion classification model that outputs a probability distribution over predefined emotion classes such as happiness, sadness, anxiety, and satisfaction. The server selects the emotion class with maximum probability and stores an emotion label together with the normalized attribute information.

The server constructs a prompt sentence for a generative AI model using a template-based algorithm. The server uses a template that specifies placeholders for generation, gender, interest fields, and emotion. The server performs string concatenation and placeholder substitution to produce a structured text instruction. For example, the server generates prompt sentences such as:

“Please generate a news article about the latest AI and smartphone technology for women in their 20s who are interested in gadgets. The article should be easy to understand and include three practical tips.”

“Please generate a blog article about balancing fitness and remote work for men in their 30s who are interested in productivity.”

“Please generate a news article about the latest AI-powered health apps for women in their 20s who are interested in wellness and mental health. The article should be around 800 words, written in an easy-to-understand style, and include three practical tips.”

The server incorporates additional parameters, such as desired length, writing style, and structural constraints, into the prompt sentence. The server may explicitly include phrases such as “around 800 words,” “friendly and informative tone,” or “include a headline and three bullet-point tips.” By encoding these constraints in text, the server controls the behavior of the generative AI model in a manner that reduces unnecessary post-processing and regeneration.

The server uses a generative AI model implemented as a neural network, such as a large-scale transformer-based language model. The generative AI model includes an embedding layer that maps tokens to vectors, a plurality of attention layers each including multi-head self-attention mechanisms and feed-forward sublayers, and an output layer that maps internal representations to token probability distributions. The server stores model parameters, such as weight matrices and bias vectors, in the memory or in dedicated accelerator memory associated with a graphics processing unit.

The server uses a training procedure for the generative AI model that includes at least the following operations: computing a loss function such as cross-entropy between predicted token distributions and ground truth tokens, performing backpropagation of the loss through the network layers, computing gradients of the loss with respect to model parameters, and updating the parameters using an optimization algorithm such as stochastic gradient descent or a variant thereof. The server or an external training environment uses data augmentation techniques, such as synonym replacement or paraphrasing, to increase the diversity of training inputs. The trained model is then deployed on the server or accessible via a remote inference endpoint.

The server selects input features for the generative AI model in the form of tokenized prompt sentences. The server uses a tokenizer that splits prompt sentences into subword units and maps them to integer token identifiers. The server supplies sequences of token identifiers to the generative AI model, along with control parameters such as maximum output length, temperature, and sampling strategy. The generative AI model, when executed, computes attention scores and context-sensitive representations for each token, and iteratively generates new tokens by sampling from output probability distributions.

The server receives generated tokens from the generative AI model and converts them into a text string representing generated content. The server stores the generated content in a text buffer associated with a user session and attaches metadata such as a generation timestamp, the prompt sentence used, and model parameter settings. The server then performs post-processing on the generated content. The server splits the text into paragraphs, detects potential headings, and inserts formatting markers. The server may also compute additional metadata such as estimated reading time or keyword tags based on term frequency analysis.

The server checks the generated content against safety criteria and constraint conditions stored in the memory. The server uses a rule-based filter to detect prohibited terms, sensitive topics, or content that violates predefined policies. The server may also use a secondary classification model to label content as safe or unsafe. If the server detects content that violates the criteria, the server modifies the prompt sentence by adding restrictive phrases such as “avoid offensive language” or “exclude explicit content,” or by narrowing the topical scope. The server then instructs the generative AI model to regenerate content based on the modified prompt. The server only forwards regenerated content that passes the safety checks to the terminal.

The server transmits display content, obtained after post-processing and safety checking, to the terminal via the communication network. The terminal receives the display content and uses its processor and graphics subsystem to render the content on the display device. The terminal may adjust layout based on device characteristics, such as screen size and resolution, under instruction or metadata provided by the server.

The user views the display content on the terminal and interacts with the content by performing operations such as scrolling, pressing “like” or “save” buttons, and requesting regeneration or different formats. The terminal captures these operations as events and sends them to the server. The server records a viewing history, including viewing duration and page transitions, and an operation history, including preference operations and regeneration requests, in the database. The server links each history record to the corresponding prompt sentence and generated content identifier.

The server performs statistical analysis of behavioral information using algorithms executed on the processor. The server aggregates viewing times per prompt template, counts preference operations per content type, and measures regeneration request rates. The server applies statistical methods such as computing averages, standard deviations, and correlations between prompt parameters (for example, length threshold or style) and user engagement metrics. Based on this analysis, the server adjusts generation conditions for subsequent prompt sentences. For instance, if the server determines that shorter content yields higher engagement for a certain combination of generation and interest fields, the server automatically changes the length constraint in future prompt sentences from “around 800 words” to “around 500 words” for that user segment.

The server thereby implements a feedback loop in which interaction data directly influences prompt generation parameters and generative AI model invocation settings. This feedback loop is realized through specific data structures (such as tables linking prompt identifiers, model parameters, and engagement metrics) and algorithmic updates to prompt templates. This design allows the server to reduce average generation time and network bandwidth usage by converging on prompt configurations that require fewer regenerations and less post-processing. The server also improves the relevance and readability of content, which reduces repeated model invocations and improves system throughput.

The server, by normalizing attribute information and encoding emotion signals as structured inputs to prompt construction, reduces redundancy and inconsistency in prompts across user sessions. This normalization enables the server to cache and reuse similar prompt templates for users with similar profiles, thereby reducing computation required for template selection and string manipulation. The server can precompute partial prompt segments for commonly occurring attribute combinations and assemble final prompt sentences by combining these segments with real-time emotion labels, which further optimizes processing time.

The terminal benefits from reduced communication load because the server can tailor content length and structure to match terminal capabilities and user preferences. For example, the server can specify in the prompt sentence that content should be suitable for small screens, with shorter paragraphs and clear headings, thus eliminating the need for multiple back-and-forth requests to reformat content. This reduces the number of network round trips and lowers latency experienced by the user.

The user, by interacting with content that has been generated under optimized conditions, experiences more responsive and relevant information delivery. The user does not need to manually specify every detail of format and style, because the server automatically infers suitable conditions from past behavioral information and emotion signals. This reduces cognitive load on the user and leverages the computational capabilities of the server to provide adaptive presentation.

In an alternative embodiment, the server executes the generative AI model locally on dedicated hardware such as a graphics processing unit or a tensor processing accelerator. The server distributes different parts of the neural network across multiple accelerators and performs parallel inference to reduce latency. The server may also employ model quantization and pruning techniques to compress model parameters while maintaining generation quality. The server can select among multiple generative AI models with different sizes and capacities based on current server load and user requirements, as encoded in the prompt sentence and generation conditions.

In another embodiment, the server employs a hybrid rule-based and neural approach for prompt sentence generation. The server first applies deterministic rules to enforce hard constraints, such as topic boundaries and safety restrictions, and then uses a neural model to refine wording or adjust style features of the prompt sentence. This hybrid approach enables the server to enforce strict technical or regulatory constraints while exploiting the expressive power of neural models for stylistic adaptation.

In a further embodiment, the server groups users into segments based on normalized attribute information and behavioral information. The server maintains cluster identifiers or segment labels in the database and associates different default generation conditions with each segment. When the user's behavior changes over time, the server recomputes segment assignment by applying clustering algorithms to the recorded histories. The server then updates the prompt sentence templates for that segment, which leads to improved alignment between model outputs and actual user behavior.

The server, by implementing these specific data structures, algorithms, and control flows, does more than merely automate human authorship. The server improves the operation of the computer system itself by reducing redundant computation, optimizing network communication patterns, and automatically tuning generative AI model parameters based on technical performance metrics. The combination of attribute normalization, emotion-aware prompt construction, safety-responsive regeneration, and feedback-based parameter adjustment results in faster convergence to effective content configurations, higher precision in content targeting, and lower error rates in terms of policy violations or irrelevant outputs. The terminal, in these embodiments, remains a relatively thin client that focuses on user interface rendering and input capture, while the server performs the heavy computational tasks. This division of labor enables scalable deployment across many terminals while centralizing optimization logic and generative AI model execution on the server. The user, through repeated interaction, indirectly trains the system's prompt generation logic without requiring direct control of model parameters, thereby contributing to continual improvement of the computer-implemented content generation pipeline.

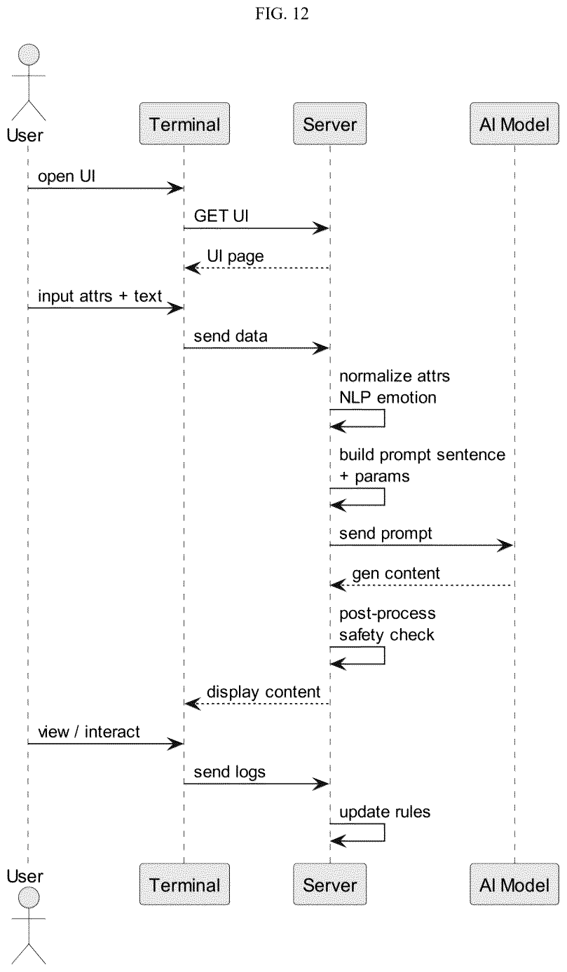

The following describes the processing flow using FIG. 12.

### Step 1

The terminal displays, on its display device, a user interface screen received from the server, including input fields for user attribute information (generation, gender, interests) and a text area for free-description information. The input of this step is markup and script data transmitted from the server, and the output is a rendered graphical interface. The terminal uses its processor and graphics subsystem to parse the received data, construct visual components, and present them to the user.

### Step 2

The user operates the terminal to enter attribute information and free-description information via touch operations or keyboard input. The input of this step is the rendered interface on the display, and the output is raw user input data captured in memory of the terminal. The user selects, for example, a generation such as “20s,” a gender such as “female,” and types interest keywords such as “AI, smartphones, gadgets,” along with a free-description sentence expressing a current concern or request.

### Step 3

The terminal collects the entered attribute information and free-description information from the input fields and packages them into a structured data object. The input of this step is the raw user input residing in user interface components, and the output is a structured record or message, for example with fields for generation, gender, interests, and free text. The terminal's processor reads the values from the interface widgets, converts them to a predefined internal representation, and temporarily stores them in memory.

### Step 4

The terminal transmits the structured data object to the server via a communication network. The input of this step is the structured record describing user attributes and free text, and the output is a network message delivered to the server. The terminal uses its communication interface to encapsulate the data into protocol packets, applies security mechanisms, and sends the packets over the network to an address associated with the server.

### Step 5

The server receives the network message from the terminal and extracts the structured user data. The input of this step is the network packet stream carrying the user attribute information and free-description information, and the output is a server-side data structure containing the same information. The server's processor uses a network stack to reassemble packets into a message, parses the message format, and stores the extracted data in working memory.

### Step 6

The server validates and normalizes the attribute information into standardized category information. The input of this step is the raw attribute information, and the output is normalized category information including at least a generation label, a gender label, and a list of interest labels. The server checks that the generation matches allowed categories, maps free-form gender labels to standard labels, and splits a single interest string such as “AI, smartphones, gadgets” into a list such as [“AI”, “smartphones”, “gadgets”] by performing string tokenization and trimming operations.

### Step 7

The server analyzes the free-description information using natural language processing to identify an emotion of the user. The input of this step is the free-description text, and the output is an emotion label such as “anxious,” “excited,” or “curious.” The server tokenizes the text into tokens, converts tokens into feature vectors, applies an emotion classification model, computes a probability distribution over emotion classes, and selects the highest-probability class as the emotion label.

### Step 8

The server stores the normalized attribute information and the identified emotion in a database or similar storage structure. The input of this step is the category information and emotion label, and the output is a persistent record containing these values associated with a user identifier or session identifier. The server's processor constructs a database command, writes the record into a table or collection, and confirms successful storage.

### Step 9

The server constructs a prompt sentence for a generative AI model based on the normalized attributes and the emotion label. The input of this step is the normalized category information and the emotion label, and the output is a textual prompt sentence that encodes generation conditions such as format, length, style, and structure. The server selects a template and substitutes values into placeholders, performing string concatenation to produce instructions such as:

“Please generate a news article about the latest AI and smartphone technology for women in their 20s who are interested in gadgets. The article should be easy to understand and include three practical tips.”

### Step 10

The server determines generation conditions for the generative AI model, such as maximum output length, sampling temperature, and allowed structure, and embeds these conditions into the prompt sentence or into separate control parameters. The input of this step is configuration data and previous analysis results, and the output is a complete set of instructions including the prompt sentence and parameter values. The server may add phrases like “around 800 words” or “use a friendly and informative tone” to the text and also prepare numeric parameter values in a control structure.

### Step 11

The server transmits the prompt sentence and the associated generation conditions to the generative AI model and initiates content generation processing. The input of this step is the assembled instruction information, and the output is a request submitted to the model execution engine. The server tokenizes the prompt sentence into token identifiers, encodes the parameters into a call structure, and sends them to a processing module that runs the generative AI model.

### Step 12

The server executes the generative AI model to generate content. The input of this step is the sequence of token identifiers representing the prompt sentence and the generation parameters, and the output is a sequence of token identifiers representing generated content. The server's processor and any attached accelerator hardware perform embedding lookups, attention computations, matrix multiplications, and non-linear transformations across multiple layers, computing probability distributions over possible next tokens and sampling or selecting tokens until a stopping condition, such as a maximum length or end token, is met.

### Step 13

The server converts the generated token sequence into a generated content text string. The input of this step is the sequence of token identifiers output from the generative AI model, and the output is natural language text representing the generated article, explanation, or script. The server uses a tokenizer's decoding function to map each token identifier back to its corresponding text fragment and concatenates these fragments to form the final text.

### Step 14

The server performs post-processing on the generated content to adjust format, structure, and metadata. The input of this step is the raw generated text string, and the output is structured display content with associated metadata. The server splits the text into paragraphs, inserts headings where appropriate, computes metrics such as word count and estimated reading time, and attaches metadata including generation timestamp and topic tags to a content object.

### Step 15

The server inspects the post-processed content against predefined safety criteria and constraint conditions. The input of this step is the structured content object and its text, and the output is either a confirmation that the content is acceptable or a detection result indicating a violation. The server scans the text using a rule-based filter and optionally applies a classification model to assign safety labels. If prohibited terms or patterns are detected, the server marks the content as violating criteria.

### Step 16

The server, when a violation is detected, modifies at least one of the prompt sentence and the generation conditions and initiates regeneration. The input of this step is the detection result indicating violation and the original prompt sentence and parameters, and the output is a modified prompt sentence and adjusted parameters. The server may add or strengthen constraints such as “avoid offensive language” or “exclude explicit content,” reduce allowed topics, or adjust model temperature. The server then repeats the content generation processing with these modified instructions to obtain new generated content.

### Step 17

The server selects acceptable content, either the initially generated content if no violation was detected or the regenerated content if a violation was present, and prepares it as final display content. The input of this step is the safety-checked content object, and the output is a finalized display content package ready to be sent to the terminal. The server may adjust layout-related metadata to suit the type of terminal, such as specifying shorter sections for small screens.

### Step 18

The server transmits the display content package to the terminal via the communication network. The input of this step is the prepared display content object with text and metadata, and the output is a network message carrying the content to the terminal. The server serializes the object into a transferable format, sets appropriate headers, and uses its network interface to send the data to the terminal's address.

### Step 19

The terminal receives the display content from the server and renders it on the display device. The input of this step is the content package received via the communication interface, and the output is a visually presented article, explanation, or script on the screen. The terminal parses the received data, maps text and structural markers to visual elements such as headings, paragraphs, and lists, and uses its graphics subsystem to draw them on the display.

### Step 20

The user views and interacts with the displayed content on the terminal. The input of this step is the rendered content on the display, and the output is user interaction events such as scrolling, pressing buttons (for example, “like,” “save,” “request another article”), or closing the content. The user manipulates the input device, and the terminal's operating system and application record these events.

### Step 21

The terminal collects user interaction events and viewing duration information and sends them to the server. The input of this step is the raw interaction events and timing information, and the output is an interaction history message transmitted to the server. The terminal timestamps events, aggregates them as necessary, and uses the communication interface to transmit a summary of the viewing history and operation history.

### Step 22

The server receives the interaction history from the terminal and records it in a database in association with the corresponding prompt sentence and generated content identifier. The input of this step is the interaction history message and identifiers for the prompt and content, and the output is a stored behavioral record linking user actions to specific generation settings. The server constructs database entries that include fields for viewing time, preference operations, regeneration requests, and references to the prompt and content.

### Step 23

The server performs statistical analysis on accumulated behavioral records to update generation conditions for future prompt sentences. The input of this step is the set of stored interaction histories and their associated prompt and parameter data, and the output is updated configuration values or template parameters for prompt construction. The server computes aggregates such as average viewing time per prompt template, calculates correlations between output length and engagement, and determines whether certain styles or formats yield better interaction. Based on these results, the server modifies default length constraints, wording preferences, or style instructions that will be inserted into subsequent prompt sentences.

### Step 24

The server applies the updated generation conditions the next time it constructs a prompt sentence for a similar user profile or user segment. The input of this step is a new set of normalized attribute information and emotion label, and the output is a new prompt sentence and parameter set that incorporates adjustments derived from previous analysis. The server thus uses its updated templates and parameter rules to generate more effective prompt sentences, such as changing a prior instruction “around 800 words” to “around 500 words” for users in a specific generation and interest group, which in turn improves processing efficiency and user satisfaction in subsequent runs.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional natural language processing systems that generate responses to user input often rely on fixed rule sets or shallow matching of input text, and therefore fail to adapt linguistic expressions to heterogeneous user attributes such as age, preference, or communication style. In many architectures, a server simply forwards raw user text to a generative AI model and returns the generated output without performing structured pre-processing or post-processing that is aware of user attributes. As a result, the generated responses may contain expressions that are inappropriate in tone, politeness level, or domain specificity for a particular user, thereby degrading user experience and reducing the practical utility of the system.

Furthermore, in typical client-server configurations, the transformation from user input text into model input and the selection of model output are implemented as ad hoc application logic. The client and server exchange unstructured payloads, and the server does not consistently normalize, tokenize, or encode the input in a way that allows efficient execution of matrix computations in the generative AI model. This leads to inefficiencies in the use of computational resources such as processors and accelerators, increases end-to-end latency, and limits scalability when a large number of concurrent user requests must be handled.

In addition, conventional systems that employ generative AI models often leave decoding and candidate selection behavior largely to generic library defaults, without any coordinated control by the server over how candidate expressions are generated and filtered according to user attributes and predefined selection conditions. Consequently, even when high-performance accelerators are available, the server does not fully exploit them to perform structured probabilistic computation and search over candidate expressions in a way that systematically improves the quality and appropriateness of the final response text.

Accordingly, there is a need for a technical mechanism that, in a client-server environment, converts user text input into structured model input data, executes matrix-based probabilistic computation for a generative AI model on an accelerator device, and performs attribute-aware selection of expressions in the model output. Such a mechanism should improve the efficiency and consistency of data processing between the terminal and the server, reduce computational overhead for text generation, and enhance the relevance and appropriateness of the generated response text, thereby improving the overall performance of the computer system as a platform for natural language interaction.

The specific processing by the specific processing unit 290 of the data processing device 12 in Example 2 is realized by the following means.

The present invention provides a server comprising a processor configured to receive character information input by a user via a terminal through a communication network; convert the received character information into structured information; analyze the structured information together with attribute information related to the user; generate a prompt sentence for input to a generative AI model based on the analysis; generate model input data by dividing the character information into unit symbol sequences, converting the unit symbol sequences into an identifier sequence, combining the identifier sequence with the attribute information, and formatting the model input data into an input format for the generative AI model; input the prompt sentence and the attribute information into the generative AI model operating on an information processing apparatus including a matrix computation device; cause the generative AI model to execute sequential probabilistic distribution computation on the model input data using the matrix computation device; obtain a plurality of candidate expressions from the sequential probabilistic distribution computation; perform a candidate selection process based on a search algorithm and predetermined selection conditions to generate a response candidate including at least one expression corresponding to the attribute information of the user; generate a response text by embedding the selected expression into a response template; encode the response text into a predetermined data format; and transmit the encoded response text to the terminal as response information to be displayed on a display device of the terminal. This enables the computer system to perform structured, attribute-aware pre-processing and post-processing around the generative AI model, to utilize matrix-based probabilistic computation on an accelerator efficiently, to reduce latency and resource waste in text generation, and to consistently produce response texts whose linguistic expressions are better adapted to individual user attributes, thereby improving the technical performance and usability of the underlying computing infrastructure.

The term “character information” refers to text data composed of one or more symbols, such as letters, numerals, punctuation marks, or other character codes, that is input by a user and processed by the system.

The term “user” refers to an entity, such as a human operator or an application program acting on behalf of a human, that provides input to the system and receives responses from the system.

The term “terminal” refers to an information processing apparatus, such as a client device including a computing unit and a display unit, that transmits user input to a server via a communication network and presents response information to the user.

The term “communication network” refers to an infrastructure that enables data transmission between the terminal and the server, including one or more wired or wireless networks such as local area networks, wide area networks, or packet-switched networks.

The term “structured information” refers to data derived from character information that has been organized into a predetermined format, such as a token sequence, a key-value representation, or a data structure, which is suitable for further computational processing by the server or by a model.

The term “attribute information” refers to information indicating one or more characteristics associated with a user, such as demographic category, preference, usage history, or communication style, which is used in analyzing and generating responses.

The term “prompt sentence” refers to a text sequence, generated or formatted by the server, that is supplied as input to a generative AI model in order to condition or control the behavior of the generative AI model.

The term “generative AI model” refers to a trained computational model, such as a machine learning model for natural language generation, that receives input data and produces output data including text or expressions based on probabilistic computation over learned parameters.

The term “information processing apparatus” refers to a computing system including at least one processor and associated resources that execute programs or models, and in the present context hosts the generative AI model.

The term “matrix computation device” refers to a hardware component, such as an accelerator or coprocessor, that is optimized for performing matrix operations, tensor operations, or other linear algebra operations used in implementing a generative AI model.

The term “model input data” refers to data that is provided to a generative AI model as input, including at least one identifier sequence corresponding to character information and, optionally, attribute information associated with a user.

The term “unit symbol sequence” refers to an ordered series of symbols, such as characters, subword units, or tokens, obtained by segmenting character information according to a predetermined rule.

The term “identifier sequence” refers to an ordered series of identifiers, such as integer indices, each identifier corresponding to a respective symbol or token in a unit symbol sequence as defined by a vocabulary or codebook.

The term “sequential probabilistic distribution computation” refers to a process in which the generative AI model calculates, for each position in an output sequence, probability values over a set of possible symbols or tokens conditioned on preceding inputs or outputs.

The term “candidate expression” refers to a text fragment, such as a word, phrase, or sentence, produced by the generative AI model as a possible part of a response, prior to a final selection process being applied.

The term “response candidate” refers to one or more candidate expressions, or a combination thereof, generated by the generative AI model and subject to subsequent selection or filtering based on predetermined conditions.

The term “search algorithm” refers to a computational procedure, such as greedy search, beam search, or sampling-based search, that explores one or more candidate sequences of expressions based on probability values output by the generative AI model.

The term “selection condition” refers to one or more rules, constraints, or criteria, such as relevance, politeness level, or avoidance of prohibited content, used to determine which candidate expressions are to be selected from among multiple candidates.

The term “response text” refers to a text sequence generated by the server that includes at least one selected expression and is intended to be presented to the user as the system's reply.

The term “response template” refers to a predetermined pattern or format for arranging one or more expressions in a response text, into which selected expressions are inserted to generate a final response.

The term “predetermined data format” refers to a format, such as a markup format, a structured text format, or a serialized data format, that is specified in advance for encoding response text for transmission to the terminal.

The term “response information” refers to data including at least the encoded response text that is transmitted from the server to the terminal for presentation to the user.

The term “display device” refers to an output apparatus, such as a screen or monitor associated with the terminal, that visually presents response information, including the response text, to the user.

In an embodiment, a server, a terminal, and a user cooperate to implement the claimed system. The server includes at least one central processing unit (CPU), at least one matrix computation device such as a graphics processing unit (GPU), a main memory, a non-volatile storage device, and a network interface. The terminal includes a CPU, a memory, a display device, an input device, and a network interface. The user operates the terminal to input character information and to view response information.

The server stores, in the non-volatile storage device, executable programs, model parameters, and configuration data. The server loads these programs and parameters into the main memory so that the CPU and the GPU can execute numerical computation. The server uses an operating system and a runtime environment that support parallel processing and GPU acceleration. For example, the server uses a machine learning library such as a tensor computation framework or a deep learning framework that provides tensor data structures, automatic differentiation, and GPU device management. The server uses a tokenizer implementation, a JSON parser, and a web application framework to process incoming data and outgoing data.

The terminal runs a web browser or a native application. The terminal displays an input field and one or more controls on the display device. The user operates the input device, such as a touchscreen or a keyboard, to enter character information as a prompt sentence in natural language. For example, the user may input the prompt sentence “Tell me the latest trendy words.”, or “How should I refuse an invitation politely?”, or “Rewrite the following sentence using trendy expressions for college students: Please share this information with your friends.” The terminal stores the character information temporarily in its memory and prepares a network request directed to the server.

The terminal uses a communication protocol stack, such as TCP/IP with an application layer protocol, to transmit the character information and, optionally, attribute information associated with the user, such as age group or preferred style, to the server. The terminal can encode the character information and the attribute information into a structured data format, and the terminal can include metadata such as timestamps or session identifiers in the request. The terminal receives, from the server, response information including a response text, and the terminal decodes and renders the response text on the display device for the user.

The server receives, via the network interface, character information input by the user and transmitted by the terminal. The server parses the structured data format using a parser running on the CPU. The server extracts the raw character information string and any attribute information. The server normalizes the character information by converting it to a canonical encoding, trimming leading and trailing whitespace, and optionally standardizing punctuation. The server then converts the normalized character information into structured information suitable for further computational processing.

The server performs tokenization by dividing the character information into unit symbol sequences. The server uses a tokenizer, such as a subword tokenizer based on byte pair encoding or a unigram language model. The server loads a vocabulary data structure from storage into memory, where each entry maps a symbol or subword unit to a unique integer identifier. The server iteratively scans the character sequence and applies tokenization rules to generate a sequence of tokens. The server looks up each token in the vocabulary and generates an identifier sequence as a sequence of integers. The server treats this identifier sequence as model input data representing the prompt sentence.

The server processes the attribute information in a similar structured manner. The server defines, in memory, a set of attribute categories such as generation, formality preference, and domain interest. The server maps each attribute value to a corresponding index, and the server optionally embeds each index into a vector representation using a small embedding matrix stored in memory. The server combines the identifier sequence and the attribute information to form model input data. For example, the server may concatenate attribute embeddings to the token embeddings or may provide attribute indices as additional conditioning inputs to the generative AI model.

The server loads a generative AI model into memory and onto the GPU. In one embodiment, the generative AI model is a Transformer-based neural network comprising an embedding layer, a plurality of self-attention layers, a plurality of feed-forward layers, and an output projection layer. The model parameters are stored as multi-dimensional arrays (tensors) containing floating-point weights and biases. The server allocates GPU memory to store these tensors and to store activation tensors during inference. The server uses tensor operations provided by the machine learning library to perform matrix multiplication, vector addition, non-linear activation functions such as rectified linear units or other activation functions, and normalization operations such as layer normalization.

The server uses a forward inference process to compute the response candidate. The server transfers the model input data, including the identifier sequence and the attribute representation, to the GPU memory. The server applies the embedding layer to convert token identifiers into dense vector embeddings. The server feeds the sequence of embeddings through the self-attention layers. Each self-attention layer computes query vectors, key vectors, and value vectors by multiplying the input embeddings by learned weight matrices. The server computes attention scores as scaled dot products of queries and keys and applies a softmax operation to obtain attention weights. The server then multiplies the attention weights by the value vectors to obtain context vectors. The server passes the context vectors through feed-forward layers consisting of linear transformations and non-linear activations. The server repeats these layers for the number of layers specified in the architecture. At each position in the sequence, the server computes a hidden representation that captures contextual information from preceding tokens and from the attribute information. The server then applies the output projection layer, which maps hidden representations to logits over a vocabulary of possible output tokens. The server converts logits to probability distributions via a softmax function. By repeating this process sequentially for each output position, the server performs sequential probabilistic distribution computation, where each step computes a probability distribution over candidate next tokens conditioned on previous tokens and attributes.

The server executes a search algorithm, such as greedy search, beam search, or top-k or nucleus sampling, to generate candidate expressions. For beam search, the server maintains multiple partial sequences with associated cumulative log probabilities in memory. At each step, the server expands each sequence by selecting a limited number of likely tokens based on probabilities computed by the model, and the server prunes less probable sequences to keep the beam size fixed. This process continues until an end-of-sequence condition is met or a maximum length is reached. The server thereby obtains a plurality of candidate expressions or response candidates.

The server applies one or more selection conditions to the candidate expressions. The server can define selection conditions as a set of rules or learned criteria, for example: matching a target politeness level, avoiding prohibited tokens, or maximizing a weighted score combining the model probability and an attribute-compatibility score. The server can compute an attribute-compatibility score by evaluating whether the candidate expression contains tokens associated with certain age groups or formality categories stored in an attribute lexicon. The server selects at least one expression that satisfies the selection conditions and that has a high combined score.

The server then generates a response text by embedding the selected expression into a response template. The server can store multiple templates in a template library indexed by context type or style. For instance, for an informational response, the server can use a template such as “Some recent trendy words are X, Y, and Z.” For a polite guidance response, the server can use a template such as “You may say: ‘S’.” The server performs string substitution or token concatenation to insert the selected expression into the appropriate positions in the template. The server may also apply post-processing rules, such as adjusting capitalization or adding punctuation, to ensure grammatical correctness.

The server then encodes the response text into a predetermined data format, such as a structured text format that can be easily parsed by the terminal. The server includes metadata such as a response identifier, a timestamp, and, optionally, information about selected expressions. The server transmits the encoded response text to the terminal via the communication network. The terminal receives the response, decodes the predetermined data format, and extracts the response text for display. The terminal renders the response text on the display device using one or more graphical user interface components.

The server thereby improves the functioning of the computer system in several technical respects. By converting character information into structured model input data using tokenization, identifier sequences, and attribute encoding, the server reduces ambiguity and enables efficient use of GPU-accelerated matrix operations. This structured processing reduces unnecessary repeated parsing and string manipulation in the GPU pipeline, thereby improving inference throughput and reducing latency. By performing sequential probabilistic distribution computation on the matrix computation device and controlling the search algorithm at the server level, the server exercises fine-grained control over candidate generation and selection, improving the accuracy and relevance of generated expressions compared to naive text forwarding.

The server uses non-conventional processing that goes beyond simple human-like reasoning or rule application. The server uses a large-scale neural network architecture that has been trained on data using gradient-based optimization. During training, the server or a training system defines a loss function, such as cross-entropy between predicted token distributions and target tokens, and uses backpropagation to compute gradients of the loss with respect to the model weights. The server updates the weights using optimization algorithms, such as stochastic gradient descent or adaptive methods, and may employ data augmentation and regularization techniques to improve generalization. The trained model, when deployed, performs numerical optimization over high-dimensional parameter spaces that cannot be practically replicated by human reasoning. The internal attention mechanisms learn complex statistical relationships among tokens and attributes, providing a non-obvious mapping from input character information and attributes to output expressions.

The server further controls memory usage and data flow between CPU and GPU to enhance computational efficiency. The server batches multiple requests into a tensor of prompt sentences where possible, shares common model parameters in GPU memory, and overlaps data transfer with computation. By structuring the identifier sequences and attribute vectors into fixed-size tensors, the server allows the GPU to perform highly parallel matrix multiplications, which leads to improvements in throughput and energy efficiency. These optimizations produce a concrete improvement in computer performance rather than simply automating human mental tasks.

The server also contributes to communication efficiency between the terminal and the server. By encoding character information and response texts into structured formats and by performing attribute-aware processing on the server side, the system avoids transmitting excessively long or redundant messages. The server can compress response templates and reconstruct full responses on the terminal, thereby reducing communication bandwidth usage. Such reduction in communication overhead is a technical effect that improves the performance of the networked computer system.

In a first variant embodiment, the server uses an encoder-decoder generative architecture, where an encoder network processes the identifier sequence and attribute information into a context representation, and a decoder network generates output tokens conditioned on that context. In this variant, the server can precompute encoder representations for frequently used prompts or attributes and reuse them, thereby reducing repeated computation and further improving response latency.

In a second variant embodiment, the server incorporates an additional attribute-scoring network that operates on candidate expressions generated by the main generative AI model. This attribute-scoring network, for example a smaller feed-forward neural network, receives as input vector representations of candidate expressions and attribute vectors, and outputs scalar scores indicating compatibility. The server multiplies or adds these scores to the log probabilities from the main model and uses the combined score in the search algorithm. This arrangement provides a technical mechanism for integrating attribute-awareness into the selection process without retraining the entire generative model, improving modularity and maintainability of the system.

In a third variant embodiment, the server dynamically adjusts decoding parameters, such as beam width or sampling temperature, based on measured latency or resource utilization. When the server detects high load, the server can lower the beam width or limit maximum output length, thereby reducing GPU computation while still preserving attribute-aware selection. This adaptive control improves overall system stability and responsiveness under varying workloads, which is a technical advantage in large-scale deployments.

The terminal can also vary in form. In one embodiment, the terminal functions as a smartphone executing a mobile application. In another embodiment, the terminal functions as a desktop computer executing a web browser. In a further embodiment, the terminal functions as an embedded device integrated into a kiosk or a vehicle. In each case, the terminal executes client-side logic that captures user input, sends character information and attribute information to the server, receives response information, and displays the response text.

Through the described structural arrangements, data representations, and algorithmic procedures, the server, the terminal, and the user interact in a way that improves computer-centric aspects such as processing speed, memory usage, communication efficiency, and response quality. The system does not merely automate human decision-making but rather introduces a specific architecture that uses a generative AI model and associated data structures to enhance the technical performance of the underlying computing devices.

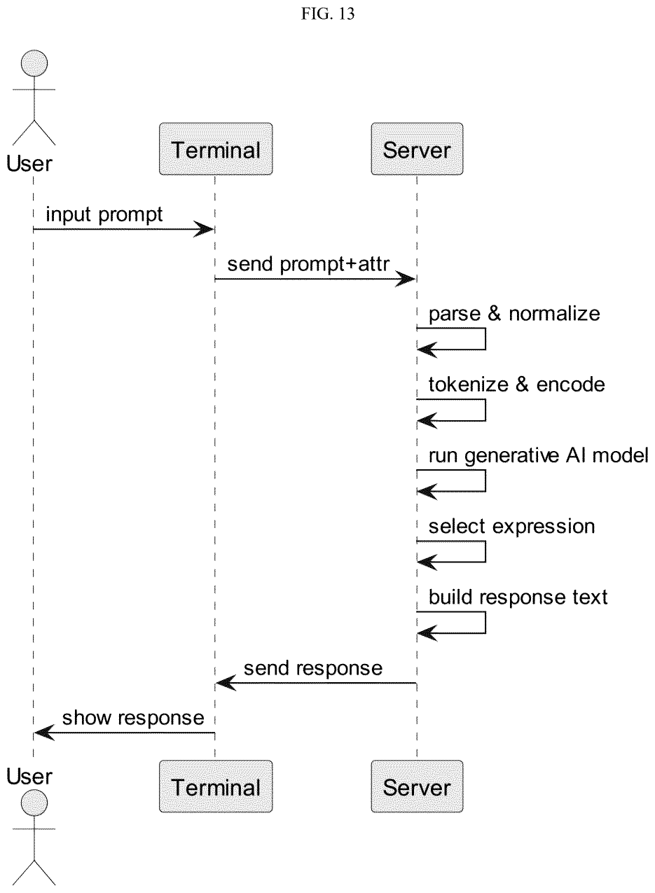

The following describes the processing flow using FIG. 13.

### Step 1

The user operates the terminal and inputs character information as a prompt sentence. The user, for example, types “Tell me the latest trendy words.” or “How should I refuse an invitation politely?” into a text input field displayed on the terminal. The input to this step is a raw text string entered by the user via a keyboard, touchscreen, or voice-to-text function. The output of this step is the prompt sentence stored in a memory area of the terminal as a character string ready to be processed by client-side software.

### Step 2

The terminal structures the user input and prepares transmission data. The terminal reads the prompt sentence from its memory and optionally reads attribute information associated with the user, such as age group or preferred style, from local storage or application settings. The input to this step is the raw prompt sentence and attribute values. The terminal combines these into a structured data object, attaches metadata such as a timestamp and session identifier, and stores this structured data in a buffer. The output of this step is a structured request payload that contains the prompt sentence and attribute information in a format suitable for network transmission.

### Step 3

The terminal transmits the structured request payload to the server over a communication network. The terminal uses a communication protocol stack to encapsulate the request payload into network packets and sends these packets to the server's network address. The input to this step is the structured request payload generated in Step 2. The terminal applies encoding and, if necessary, encryption at the transport or application layer, and then transmits the data via its network interface. The output of this step is a sequence of network packets carrying the prompt sentence and attribute information toward the server.

### Step 4

The server receives the network packets and reconstructs the structured request payload. The server's network interface collects incoming packets, and the server's protocol stack reassembles these packets into a complete message. The input to this step is the sequence of network packets transmitted by the terminal. The server verifies packet integrity, performs decryption if required, and stores the reconstructed message in a receive buffer in main memory. The output of this step is the structured request payload accessible to application-layer processing on the server.

### Step 5

The server parses the structured request payload and extracts character information and attribute information. The server executes a parser program on the CPU to read the received data. The input to this step is the structured request payload stored in the receive buffer. The server decodes the data representation, separates fields, and obtains the prompt sentence as a character string together with user attribute values such as generation, formality preference, or interests. The output of this step is a normalized internal representation consisting of the prompt sentence and a set of attribute values stored in server memory.

### Step 6

The server normalizes the prompt sentence and prepares it for tokenization. The server receives as input the raw prompt sentence from Step 5. The server applies text normalization operations such as converting to a standard character encoding, removing or unifying control characters, trimming leading and trailing spaces, and standardizing punctuation and case according to predefined rules. The server may also replace certain sequences with canonical forms (for example, converting multiple spaces to a single space). The output of this step is a cleaned prompt sentence string that is more suitable for deterministic tokenization.

### Step 7

The server tokenizes the normalized prompt sentence and generates an identifier sequence. The server uses a tokenizer component that operates on the cleaned text. The input to this step is the normalized prompt sentence from Step 6. The server consults a stored vocabulary and segmentation rules to divide the sentence into unit symbol sequences, such as subword tokens. The server then maps each token to a corresponding integer identifier defined in the vocabulary. The server constructs an ordered list of these integer identifiers and stores them in a tensor or array data structure. The output of this step is an identifier sequence representing the prompt sentence as numerical data.

### Step 8

The server converts attribute information into numerical form and combines it with the identifier sequence. The server takes as input the attribute values extracted in Step 5 and the identifier sequence produced in Step 7. The server maps each attribute value to an index or a one-hot vector according to predefined attribute dictionaries. The server optionally passes these indices through an embedding table to obtain low-dimensional attribute vectors. The server then combines the attribute vectors with the token identifiers, for example by creating a data structure that pairs each prompt with its associated attribute vector or by preparing separate tensors for prompt tokens and attributes. The output of this step is model input data that includes a token identifier tensor and an attribute representation tensor.

### Step 9

The server transfers the model input data to a matrix computation device and sets up the generative AI model for inference. The server receives as input the model input data from Step 8 and the generative AI model parameters stored in server memory. The server loads the model parameters into the matrix computation device memory if not already loaded and allocates buffer space for activations and intermediate results. The server copies the token identifier tensor and attribute tensor from main memory to device memory using a device-specific transfer mechanism. The output of this step is the model input data residing in the device memory together with an initialized generative AI model ready to perform numerical computation.

### Step 10

The server performs a forward inference of the generative AI model to compute probabilistic distributions over output tokens. The server inputs the token identifiers and attribute representations stored in device memory into the model layers. The input to this step is the device-resident model input data from Step 9. The server executes tensor operations that include embedding lookup, matrix multiplication for attention and feed-forward layers, non-linear activation functions, and normalization operations. For each potential output position, the server computes a vector of logits over the output vocabulary and applies a softmax function to obtain a probability distribution. The output of this step is a sequence of probability distributions over tokens, or intermediate hidden states suitable for decoding, stored in device memory.

### Step 11

The server executes a search algorithm to generate candidate expressions based on the probability distributions. The server uses as input the probability distributions or hidden states calculated in Step 10. The server applies a decoding strategy such as greedy search, beam search, or sampling, using iterative steps to extend partial sequences and compute cumulative scores. The server maintains data structures that track candidate sequences, their probabilities, and termination conditions. Through repeated selection and expansion operations, the server generates one or more sequences of token identifiers representing candidate expressions. The output of this step is a set of candidate sequences or response candidates stored in server memory.

### Step 12

The server evaluates candidate expressions against selection conditions and selects an appropriate expression. The server takes as input the candidate sequences from Step 11 and the attribute information and selection rules stored on the server. The server decodes each candidate sequence into text, analyzes the text to detect properties such as politeness level or presence of prohibited terms, and computes a combined score that may include model probability and attribute-compatibility scores. The server discards candidates that violate constraints and selects the candidate expression or expressions with the highest scores. The output of this step is at least one selected expression that satisfies the selection conditions.

### Step 13

The server generates a response text by inserting the selected expression into a response template. The server uses as input the selected expression from Step 12 and a stored template corresponding to the type of response. The server performs text concatenation or placeholder substitution to integrate the expression into the template, for example creating a sentence such as “Some recent trendy words are lit, vibe, and going viral.” or “You may say: ‘I'm afraid I won't be able to attend, but thank you very much for the invitation.’” The server may apply post-processing rules to adjust spacing and punctuation. The output of this step is a complete response text string suitable for presentation to the user.

### Step 14

The server encodes the response text into a predetermined data format and transmits it to the terminal. The server receives the response text from Step 13 as input. The server wraps the response text into a structured object that may include a response identifier, timestamp, and any additional metadata. The server encodes this object into a format suitable for network transfer and places the encoded data into a send buffer. The server's network interface then transmits the encoded response information as network packets to the terminal. The output of this step is the response information in transit over the communication network toward the terminal.

### Step 15

The terminal receives the response information and reconstructs the response text. The terminal uses as input the network packets sent by the server in Step 14. The terminal's protocol stack reassembles the packets, verifies integrity, and decodes the structured data format to extract the response text and optional metadata. The terminal stores the response text in a memory area accessible to the user interface module. The output of this step is the decoded response text ready to be rendered on the display device.

### Step 16

The terminal displays the response text to the user and allows further interaction. The terminal reads the response text from memory as input. The terminal updates graphical user interface components on the display device to present the response text, such as inserting it into a chat bubble or response panel. The terminal may scroll the view to bring the latest response into view and may highlight selected expressions if desired. The output of this step is the visual presentation of the response text to the user, after which the user can decide to enter another prompt sentence, thereby repeating the processing flow.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information processing systems that display messages or content to end users frequently rely on static rule-based selection or simple keyword matching. In such systems, a server typically receives input text from a user terminal and returns a preconfigured response or a response selected from a small set of patterns. These approaches do not fully utilize rich user attribute data and behavior history data, and do not accurately reflect the user's current emotional state in the generated content. As a result, the system often outputs messages that are generic, context-insensitive, or not aligned with user expectations, which degrades the quality of user interaction.

Furthermore, even when machine learning models are introduced, existing systems generally treat generative models as opaque components and pass only raw text as input. They do not systematically integrate emotion data, user attribute data, and behavior history data into a structured representation that is then converted into a precise prompt sentence for a generative AI model. Consequently, the generative model may produce verbose, off-target, or inconsistent outputs, which requires additional manual filtering and tuning. This leads to inefficiencies in computation, increased latency, and unstable user experience.

Additionally, many current architectures do not tightly couple the generation pipeline with the user interface update mechanism. Generated content is often injected into the user interface in an ad-hoc manner, without a well-defined data format that allows dynamic rewriting of document structures on the user terminal. This lack of integration makes it difficult to reliably deliver personalized messages in real time while maintaining a robust and maintainable front-end architecture.

From a computer technology perspective, there is a need for an improved server-side processing architecture that (i) transforms heterogeneous user inputs into structured data including emotion data, user attribute data, and behavior history data; (ii) uses this structured data to construct prompt sentences that condition a generative AI model in a controlled and use-case-specific manner; (iii) post-processes the generative output to select suitable phrases or sentences according to evaluation rules and emotion data; and (iv) outputs the final personalized message in a display data format that can dynamically update document objects on the user terminal. Such an architecture can improve computational efficiency, controllability of a generative AI model, and real-time responsiveness of the user interface, thereby providing a technical improvement over conventional systems.

The specific processing by the specific processing unit 290 of the data processing device 12 in Application Example 2 is realized by the following means.

The present invention provides a server comprising a processor configured to receive user information including text data and user attribute data from a user terminal, to apply natural language processing to the text data to identify emotion data, to integrate the emotion data with the user attribute data and behavior history data to generate structured data, to construct a generation input sentence by template processing based on the structured data, to generate a prompt sentence for a generative AI model based on the generation input sentence, to input the prompt sentence to the generative AI model and execute an inference process to obtain response information including expression information, to select at least one phrase or sentence from the response information according to evaluation rules and the emotion data and to generate personalized message information, to format the personalized message information into display data including structured markup and script code capable of dynamically updating a document object on the user terminal, and to update the behavior history data using additional input or operation history from the user terminal so that subsequent structured data, prompt sentences, and personalized message information are adaptively modified. This enables the computing system to more effectively condition the generative AI model using rich contextual data, to generate controlled and context-appropriate responses, and to deliver the responses in a format that achieves real-time, dynamic updates of the user interface, thereby improving the overall performance, responsiveness, and personalization capabilities of the computer-based messaging system.

The term “processor” refers to a hardware and/or software based information processing unit, such as a central processing unit, a graphics processing unit, or a combination thereof, that executes instructions to perform data processing and control operations described in the claims.

The term “user terminal” refers to an information processing apparatus operated by a user, such as a personal computer, a smartphone, a tablet, or a head-mounted display device, that transmits user information to a server and displays information received from the server.

The term “input interface” refers to a hardware and/or software interface, such as a web form, an application programming interface, or a communication protocol endpoint, through which the processor receives user information from the user terminal.

The term “user information” refers to data transmitted from the user terminal to the server, including at least text data representing user input and user attribute data representing characteristics of the user.

The term “text data” refers to character string data input by the user or derived from user input, which is suitable for natural language processing, and which may include statements, questions, or other linguistic expressions.

The term “user attribute data” refers to data representing characteristics of the user, such as demographic information, preference information, interest categories, usage environment, or any other attribute associated with the user.

The term “behavior history data” refers to data representing past operations or interactions by the user, such as access logs, click logs, prior inputs, content viewing records, or other historical activity records.

The term “natural language processing algorithm” refers to a software implemented procedure that analyzes text data to extract linguistic or semantic information, including at least tokenization, parsing, classification, sentiment or emotion estimation, or similar processing.

The term “emotion data” refers to data representing an estimated emotional state of the user, such as joy, sadness, stress, fatigue, excitement, or other affective categories, obtained by applying a natural language processing algorithm to the text data.

The term “structured data” refers to data in which the emotion data, the user attribute data, and the behavior history data are integrated into a predetermined format such as a record, an object, or a key-value collection, to be used as an input for subsequent processing.

The term “template processing” refers to a procedure in which predefined sentence patterns including placeholders are combined with the structured data to generate a concrete generation input sentence or prompt sentence.

The term “generation input sentence” refers to a natural language sentence or sequence constructed by template processing based on the structured data, which serves as an intermediate representation for generating a prompt sentence.

The term “prompt sentence” refers to a natural language input sequence supplied to a generative AI model to condition the behavior of the model and to cause the model to generate response information according to the structured data.

The term “generative AI model” refers to a parameterized information processing model, such as a neural network language model, configured to generate text or other content in response to an input prompt sentence, and implemented using numerical operations including at least matrix operations and attention operations.

The term “inference process” refers to a process executed by the generative AI model in which the prompt sentence is converted into internal representations and numerical computations, including matrix multiplications, non-linear transformations, and attention calculations, are performed to produce output tokens representing response information.

The term “response information” refers to data output by the generative AI model in response to the prompt sentence, including at least one phrase, sentence, or other expression information corresponding to the emotion data and the user attribute data.

The term “expression information” refers to one or more words, phrases, or sentences contained in the response information and suitable to be presented to the user as part of a message.

The term “evaluation rules” refers to predefined criteria, conditions, or scoring functions used by the processor to select at least one phrase or sentence from among a plurality of phrases or sentences in the response information, based on the emotion data and optionally other contextual data.

The term “personalized message information” refers to message data generated by the processor by selecting and combining phrases or sentences from the response information according to the evaluation rules and the emotion data, the message data being tailored to an individual user.

The term “display data” refers to data formatted for presentation on the user terminal, including markup data, script data, or structured data, which describes how the personalized message information is to be visually or otherwise presented.

The term “communication network” refers to a wired or wireless data transmission infrastructure, including at least the Internet, local area networks, or mobile communication networks, used to transmit data between the server and the user terminal.

The term “structured markup document” refers to a document described in a markup language, such as a hypertext markup language or an equivalent, in which user interface elements and document structure are defined in a hierarchical form.

The term “script code” refers to program instructions written in a scripting language executable on the user terminal, configured to manipulate document objects and update the user interface based on the display data.

The term “document object” refers to a node or element in a document object model or equivalent representation, which is manipulated by the user terminal to update the visual presentation of the personalized message information.

The term “prompt template” refers to a predefined sentence pattern or template, associated with a particular use case, into which the structured data is inserted to generate a use-case-specific prompt sentence.

The term “use case” refers to a functional category of message generation, including at least an advertising message generation use case, an encouragement message generation use case, a vocabulary selection message generation use case, or an information recommendation message generation use case.

In one embodiment, a server implements the claimed system as a network-accessible application executed on a hardware platform including at least one central processing unit (CPU), optional graphics processing units (GPUs), a main memory, a non-volatile storage device, and a network interface. The server executes software components including an operating system, a web server, an application framework, a database management system, a natural language processing engine, and a generative AI model implementation. The server communicates with multiple terminals operated by users through a communication network. A terminal operates as a client device such as a personal computer, a tablet, a smartphone, or a head-mounted display. The terminal executes a web browser or a native application that presents a user interface to the user. The user interface includes input fields, display regions, and script code configured to send user information to the server and to receive and display personalized message information from the server.

A user operates the terminal to access a web page or application provided by the server. The user enters text data, such as sentences expressing a current situation or feeling, and also causes user attribute data, such as age range, gender category, interest categories, and optional behavior history identifiers, to be transmitted from the terminal to the server. The terminal converts the user's input into structured user information, for example as a set of key-value pairs, and transmits the user information over the communication network.

The server receives the user information through an input interface implemented as an endpoint of a communication protocol. The server parses the incoming user information to extract text data and user attribute data, and associates the user information with an internal user identifier. The server stores the user attribute data and behavior history data in a database system such as a relational database. The database stores, in one embodiment, tables for user profiles, behavior logs, and past generated messages, where each table row is indexed by a user identifier and includes structured fields for age group, gender category, interest tags, and behavioral event types.

The server applies a natural language processing algorithm to the text data to identify emotion data. In one implementation, the server uses a natural language processing engine that carries out tokenization, part-of-speech tagging, syntactic parsing, and semantic classification. The server converts the text data into numerical feature vectors, for example by using word embeddings or subword embeddings. The server then inputs these feature vectors to an emotion detection model, which may be realized as a neural network, such as a recurrent neural network, a convolutional network, or a transformer-based encoder. The emotion detection model outputs a probability distribution over emotion categories, such as joy, sadness, stress, fatigue, or excitement. The server selects the emotion category with the highest probability as the emotion data, and optionally retains the full probability distribution for further processing. By performing this numerical classification on the server, the system achieves a consistent, quantitative representation of user emotion that can be reused across different message generation scenarios.

The server integrates the emotion data, the user attribute data, and the behavior history data to generate structured data. In one embodiment, the server constructs a structured object that includes fields for emotion_type, emotion_confidence, age_group, gender_category, interest_categories, and a compact representation of behavior history, such as counts or embeddings of past interactions. The server may compute a behavior embedding vector using a separate model that maps sequences of user actions into a fixed-dimensional representation. By integrating the data into a structured form, the server creates a compact and computable context representation that can condition subsequent processing stages.

The server performs template processing to construct a generation input sentence based on the structured data. The server maintains a set of prompt templates, each associated with a particular use case such as advertising message generation, encouragement message generation, vocabulary selection, or information recommendation. Each prompt template is a natural language pattern containing placeholders for emotion type, user attributes, and optional behavior descriptors. For example, the server uses a template such as:

“Target user: {age_group}, {gender_category}. Emotion: {emotion_type}. Interests: {interest_categories}. Generate a short Japanese advertising phrase suitable for this user.”

The server fills in the placeholders using values from the structured data to form a concrete generation input sentence. In a specific example, where the structured data indicates a young user interested in fashion with a positive emotion, the server constructs a generation input sentence such as:

“Target user: young, female. Emotion: joy. Interests: fashion, casual style. Generate a short Japanese advertising phrase suitable for this user.”

The server then generates a prompt sentence for a generative AI model based on the generation input sentence. In some embodiments, the generation input sentence itself serves as the prompt sentence. In other embodiments, the server wraps the generation input sentence with additional instructions, such as specifying language, style, or length constraints.

Example prompt sentences used by the server include:

“Target: young people, category: fashion, style: casual. Please generate the best advertising copy in Japanese.”

“A woman in her 20s feels excited about starting a new project. Please generate an encouraging message about taking on a new challenge in Japanese.”

“The user feels stressed. Please generate a short, gentle encouraging message in Japanese that fits this state.”

“Analyze the following text, identify the emotion, and propose a matching Japanese advertisement: ‘I had a great time today.’.”

“User feels tired. Suggest a gentle, supportive Japanese phrase that encourages rest.”

“User's interest: outdoor gear. Based on the behavior history, generate a short Japanese ad such as ‘Check out the latest outdoor gear!’.”

The server inputs the prompt sentence into a generative AI model implemented as a learned neural network. In one embodiment, the generative AI model is a transformer-based language model comprising multiple layers of self-attention and feed-forward sublayers. Each layer performs matrix multiplications between an input sequence representation and learned weight matrices, computes attention scores between tokens, and applies non-linear activation functions. The model parameters are stored in the server's memory and can be executed on GPU hardware to accelerate matrix operations. The server converts the prompt sentence into token identifiers using a tokenizer, loads the corresponding embedding vectors, and feeds them through the transformer network to compute a sequence of output token probabilities. The server then decodes the output tokens using a decoding strategy, such as greedy decoding or sampling, to generate response information.

The server does not treat the generative AI model as a generic black box. The model is trained beforehand by the server using a corpus of text data, with supervised fine-tuning on tasks such as conditional text generation and style adaptation. During training, the server applies a loss function, such as cross-entropy between predicted token distributions and ground-truth tokens, and updates the model weights using a gradient-based optimization method. The server may employ regularization techniques and data augmentation, such as adding paraphrased user texts or simulated emotion labels, to improve robustness. As a result, the generative AI model is tuned to respond sensitively to the structured information encoded in the prompt sentence, rather than simply replicating generic language patterns.

The server receives the response information from the generative AI model. The response information includes at least one phrase or sentence and may include multiple candidate expressions. The server then selects at least one phrase or sentence based on evaluation rules and the emotion data. The evaluation rules may compute a score for each candidate phrase using features such as token length, presence of certain semantic categories, alignment with the target emotion, and compliance with prohibited word lists. The server may implement a scoring function that increases the score for phrases containing positive sentiment markers when the emotion data indicates joy, or calming markers when the emotion data indicates stress or fatigue. In addition, the server may restrict selection to phrases below a certain length to reduce display clutter on small terminals.

The server generates personalized message information by combining one or more selected phrases with fixed wording or layout patterns. For example, when the generative AI model outputs phrases like “Real cool.” and “seriously stylish” for a fashion-related use case, the server may generate a personalized advertising message such as:

“Real cool. Check out our seriously stylish new collection.”

In an encouragement use case, when the emotion data indicates fatigue and the user text is “I'm tired today.”, the generative AI model may produce a phrase like “Relax, tomorrow will be a better day.”. The server adopts this phrase as the personalized message information, optionally adding contextual headers or labels.

The server formats the personalized message information into display data that can dynamically update a document object on the terminal. In one embodiment, the server constructs a structured markup document in a markup language and embeds the personalized message information in a designated element. The server also generates script code in a scripting language that identifies a target document object, such as a message area on the web page, and rewrites its content when the display data is received. The server transmits the display data to the terminal through the communication network.

The terminal receives the display data and executes the script code in a runtime environment of the browser or application. The terminal rewrites the content of a document object associated with the user interface element and renders the personalized message information in real time. By using structured markup and script code, the terminal can update the display without reloading the entire page, thereby reducing communication load and improving responsiveness.

The server also accumulates additional input or operation history data sent from the terminal, such as whether the user clicked on a generated message, closed it, or requested more information. The server stores these events in the behavior history data and updates aggregated features used in the structured data. Over time, this adaptive update of structured data influences subsequent prompt sentence generation and personalized message generation, leading to more relevant and efficient outputs. From a technical perspective, this closed-loop design allows the server to adjust internal context representations and reduce unnecessary or redundant content generation, which improves computation efficiency in repeated interactions.

The described architecture improves computer technology in several ways. First, by transforming heterogeneous user inputs into structured data and then into precise prompt sentences, the server reduces entropy in the input space of the generative AI model. This focused conditioning leads to more accurate and shorter outputs, which reduces the average number of tokens generated per request and thus reduces computation time on the model. Second, by employing explicit evaluation rules and emotion-aware selection, the server avoids presenting irrelevant or off-target generated content, thereby reducing the need for repeated requests and lowering network traffic. Third, by outputting display data that supports incremental document updates, the system reduces the amount of data transmitted over the network and the rendering workload on the terminal, which results in faster interface updates and lower resource consumption.

The server applies a non-conventional processing sequence that differs from manual or purely rule-based methods. Human operators typically read user text and craft a response directly, while the server operates by constructing an intermediate, machine-oriented structured representation and by using template-driven prompt design to manage the behavior of a large-scale generative AI model. This processing uses machine-computable features and numerical optimization methods that are not available in human workflows. The generative AI model incorporates a multi-layer attention-based neural network that processes the entire prompt sentence and context in parallel on GPU hardware, which enables high-throughput generation for many users simultaneously. The combination of structured data, template-based prompt construction, neural inference, and rule-based post-selection forms a hybrid algorithm that is specifically tailored to the capacity and limits of modern computing hardware and is not a mere automation of human reasoning.

In alternative embodiments, the server may employ different kinds of generative AI models, such as encoder-decoder architectures or recurrent networks, and may use different optimization criteria for training, such as reinforcement learning based on user interaction feedback. The server may also vary the definition of structured data; for example, the server may include device type, network conditions, or screen size as additional fields to adapt message length and complexity. The natural language processing engine may be replaced or supplemented with external services that provide emotion scores or topic labels, as long as the server converts these outputs into emotion data and integrates them into the structured data.

The terminal may be implemented as a native application rather than a browser-based client. In such a case, the terminal still receives display data in a structured format, and its runtime environment manipulates internal view objects analogous to document objects to present the personalized message information. The user may use voice input instead of text; the terminal or the server may perform speech recognition to convert audio signals into text data before applying the described processing. These variations do not depart from the essential operation in which the server identifies emotion data, constructs structured data, generates a prompt sentence for a generative AI model, post-processes response information, and outputs personalized message information in a display-ready format.

By structuring the data flows and algorithmic steps as described, the system achieves improved processing speed, reduced error rates in emotion-conditioned generation, and lower communication overhead. As a result, the system provides a concrete technical improvement in computer-based message generation and user interface updating, rather than implementing only an abstract idea or business method.

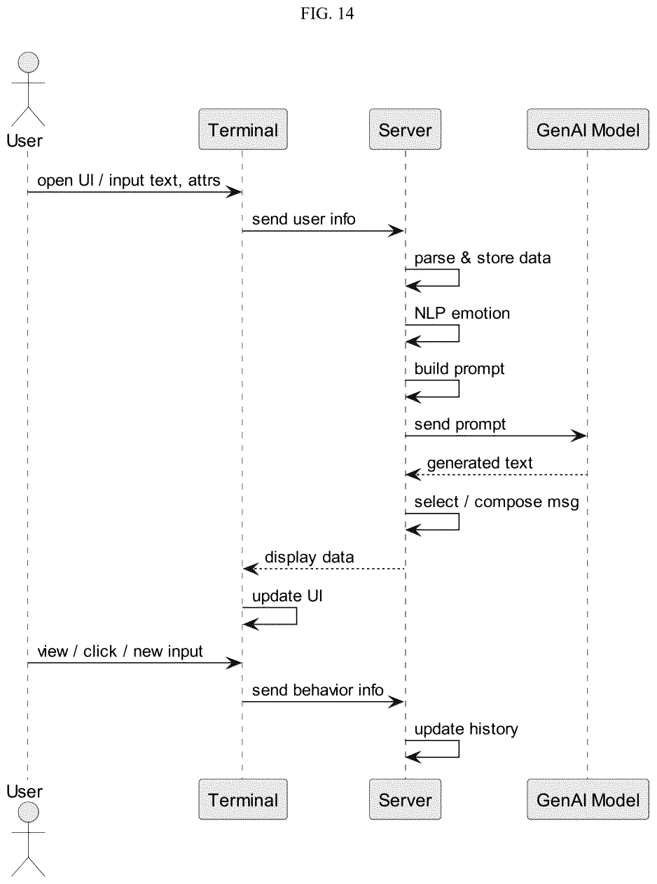

The following describes the processing flow using FIG. 14.

### Step 1

User operates the terminal and opens an application or web page provided by the server.

User views an input screen comprising text input fields and optional selectors for age group, gender category, and interest categories.

Input: screen elements displayed by the terminal (no user data yet).

Output: user-entered text data and user-selected attribute values present in the terminal's memory but not yet transmitted.

Terminal captures the user's keystrokes and selections using event handlers implemented in a scripting environment or native UI framework, and stores the values in an internal data structure such as a key-value map.

### Step 2

Terminal constructs user information to be sent to the server.

Input: local data structure containing text data (for example, “Today I feel tired”) and user attribute data (for example, “age_group: young adult”, “gender_category: female”, “interest_categories: travel, wellness”).

Output: serialized user information suitable for network transmission, for example an HTTP request body containing structured fields.

Terminal converts the local data structure into a structured format such as a set of key-value pairs, encodes it (for example, into JSON or form-encoded data), attaches it to an HTTP POST request, and sets appropriate headers including a user identifier or session identifier.

### Step 3

Terminal transmits the user information to the server over a communication network.

Input: HTTP request prepared in Step 2.

Output: network packets containing the user information delivered to the server's network interface.

Terminal uses a network stack to establish or reuse a secure connection to the server, segments the HTTP request into packets, and sends the packets through the network.

### Step 4

Server receives and parses the user information.

Input: HTTP request containing serialized user information from the terminal.

Output: internal representation of user information including text data and user attribute data.

Server terminates the transport layer connection, passes the HTTP request to an application framework, and uses a parser to decode the request body. Server extracts fields such as “text”, “age_group”, “gender_category”, and “interest_categories” and stores them in an internal object associated with a user identifier.

### Step 5

Server stores and updates user attribute data and behavior history data.

Input: internal user information object from Step 4.

Output: updated database records representing user attributes and appended behavior history entries.

Server opens a connection to a database system, constructs and executes commands that insert or update rows in a user profile table and a behavior history table, and commits the transaction. Server records facts such as “user submitted text at current timestamp” and “user specified particular interests,” converting these facts into structured fields.

### Step 6

Server prepares text data for natural language processing.

Input: raw text data extracted in Step 4 (for example, “Today I feel tired”).

Output: cleaned and normalized text data suitable for feature extraction.

Server applies preprocessing operations including character normalization, lowercasing where appropriate, removal or replacement of control characters, and optional language-specific token boundary adjustments. Server produces a normalized text string or token list for subsequent analysis.

### Step 7

Server applies a natural language processing algorithm to estimate emotion data.

Input: normalized text data from Step 6.

Output: emotion data including at least one emotion category and an associated confidence value.

Server converts the normalized text into numerical features, for example by mapping tokens to embedding vectors. Server feeds the feature sequence into an emotion detection model, such as a neural network classifier, and executes numerical computations including matrix multiplications, non-linear activations, and normalization. Server obtains a probability distribution over emotion categories, selects the category with maximum probability (for example, “fatigue”), and constructs emotion data containing the chosen category and its probability.

### Step 8

Server constructs structured data by integrating emotion and user information.

Input: emotion data from Step 7, user attribute data from Step 5, and behavior history data from the database.

Output: structured data object containing fields representing context for generation.

Server retrieves recent behavior history records for the user, aggregates them into summary features such as counts or behavior embeddings, and combines these features with fields such as age_group, gender_category, interest_categories, and emotion_type. Server stores the combined values in a structured object, for example an associative array or record, to be used as a single context input.

### Step 9

Server selects a prompt template corresponding to a use case.

Input: structured data from Step 8.

Output: selected prompt template identifier and template text pattern.

Server applies logic that maps combinations of emotion_type and interest_categories to use cases such as “advertising message”, “encouragement message”, “vocabulary selection”, or “information recommendation”. Based on the selected use case, server retrieves a stored prompt template that includes placeholders for context fields. For example, when emotion_type is “joy” and interests include “fashion”, server selects a fashion advertising template.

### Step 10

Server performs template processing to generate a generation input sentence.

Input: selected prompt template and structured data from Step 9.

Output: generation input sentence in natural language with placeholders replaced by concrete values.

Server locates placeholders in the template, such as {age_group}, {gender_category}, {emotion_type}, and {interest_categories}, and replaces them with corresponding values from the structured data. Server concatenates static text fragments and substituted values to form a coherent sentence, for example: “Target: young people, category: fashion, style: casual. Please generate the best advertising copy in Japanese.”

### Step 11

Server generates a prompt sentence for the generative AI model.

Input: generation input sentence from Step 10.

Output: prompt sentence to be used as input for the generative AI model.

Server optionally wraps the generation input sentence with additional instructions or constraints, such as specifying maximum length or tone, and stores the resulting text as the prompt sentence. In some configurations, server uses the generation input sentence directly as the prompt sentence without additional modification.

### Step 12

Server tokenizes the prompt sentence and prepares model input.

Input: prompt sentence from Step 11.

Output: sequence of token identifiers and related masks suitable for the generative AI model.

Server uses a tokenizer associated with the generative AI model to segment the prompt sentence into subword units or tokens, maps each token to a numeric identifier using a vocabulary table, and constructs input tensors such as token ID sequences and attention masks, which indicate valid positions for computation.

### Step 13

Server executes inference on the generative AI model.

Input: tokenized prompt sentence and model parameters stored in memory.

Output: response token sequences representing generated text.

Server loads the tokenized input onto a processor, such as a GPU, and propagates the input through layers of the generative AI model. Each layer performs matrix multiplications between input vectors and learned weight matrices, computes self-attention weights between tokens, applies non-linear activations, and normalizes intermediate results. Server iteratively generates output tokens by computing probability distributions at each step and selecting next tokens using a decoding strategy. Server concatenates generated token identifiers into a response sequence.

### Step 14

Server decodes the response token sequence into response information.

Input: response token sequence from Step 13.

Output: response information containing text strings, phrases, or sentences.

Server maps token identifiers back to text units using the vocabulary, joins the units to form coherent text segments, and splits the text into phrases or sentences based on punctuation or model output markers. Server stores the resulting phrases or sentences in a collection associated with the original prompt sentence.

### Step 15

Server evaluates and selects phrases or sentences based on evaluation rules and emotion data.

Input: collection of candidate phrases or sentences from Step 14 and emotion data from Step 7.

Output: selected phrase or sentence set to be included in personalized message information.

Server applies evaluation rules that score each candidate according to features such as length, presence of target keywords, sentiment alignment with the emotion_type, and absence of prohibited expressions. Server may compute an overall score as a weighted combination of features and select the highest scoring candidate or a small subset of top candidates. For example, when emotion_type is “fatigue”, server favors phrases containing calming expressions and penalizes overly energetic language.

### Step 16

Server composes personalized message information.

Input: selected candidate phrases or sentences from Step 15 and optional fixed text patterns.

Output: personalized message information as a coherent message string or structured content.

Server concatenates selected phrases with static templates, inserts punctuation and connective words, and generates a final text such as: “Relax, tomorrow will be a better day.” or an advertising message incorporating phrases like “Real cool.” and “seriously stylish.” Server may also attach metadata such as message type or timestamp.

### Step 17

Server formats personalized message information into display data.

Input: personalized message information from Step 16.

Output: display data including structured markup and script instructions for the terminal.

Server embeds the message text into a template for a markup document, assigns it to a specific element identifier, and generates script code that can locate and update the corresponding document object on the terminal. Server packages the markup and script code into a response structure suitable for transmission, such as an HTTP response body.

### Step 18

Server transmits the display data to the terminal.

Input: display data from Step 17.

Output: network response containing display data arriving at the terminal.

Server sends an HTTP response containing the display data through the communication network, sets appropriate headers indicating content type and encoding, and completes or maintains the connection according to protocol rules.

### Step 19

Terminal receives the display data and updates the user interface.

Input: HTTP response containing display data from the server.

Output: updated on-screen content that includes the personalized message information.

Terminal parses the markup and script components of the display data, executes the script code in a runtime environment, locates the target document object or view component, and replaces or inserts the personalized message text. Terminal re-renders the affected part of the screen so that the user can view the updated message without reloading the entire interface.

### Step 20

User views and optionally interacts with the personalized message.

Input: displayed personalized message information on the terminal screen.

Output: user actions such as clicks, dismissals, or new text inputs that can be sent back to the server.

User reads the personalized message and may choose to click a related link, close the message, or enter a new text describing a different feeling or request. Terminal records these actions as operation events and prepares additional user information that can be transmitted to the server, which, in subsequent executions of the above steps, will be incorporated into behavior history data and used to refine future prompt sentences and generated messages.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

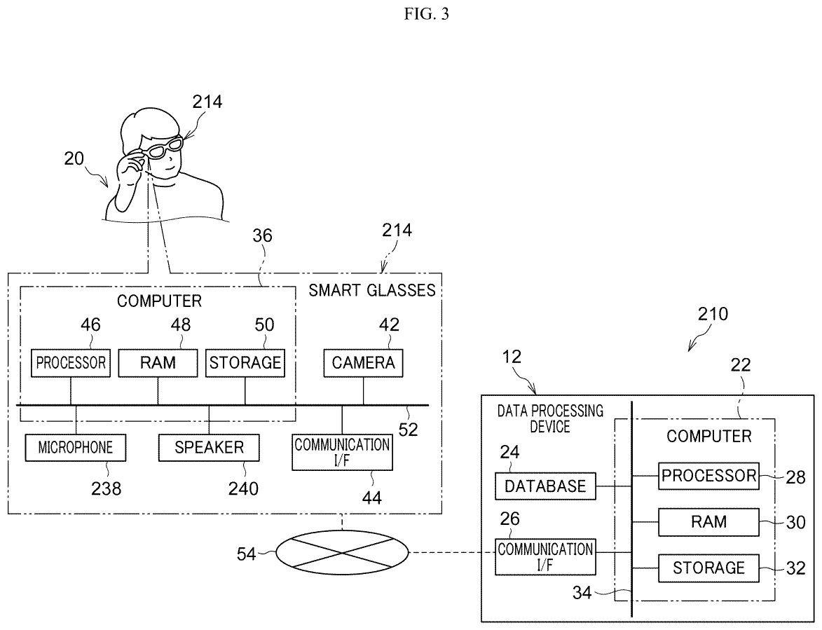

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

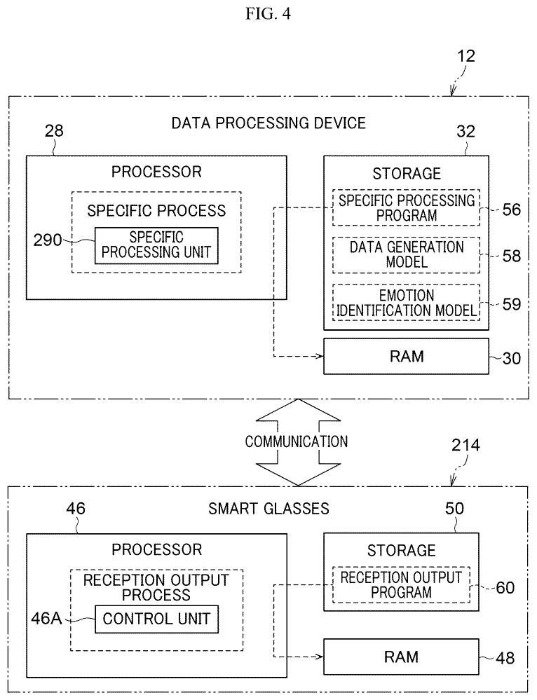

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

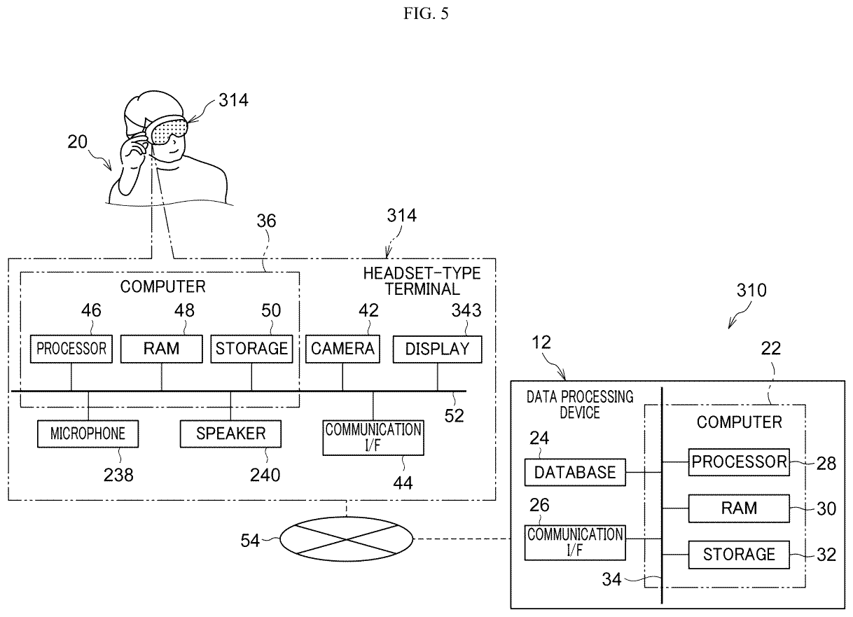

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

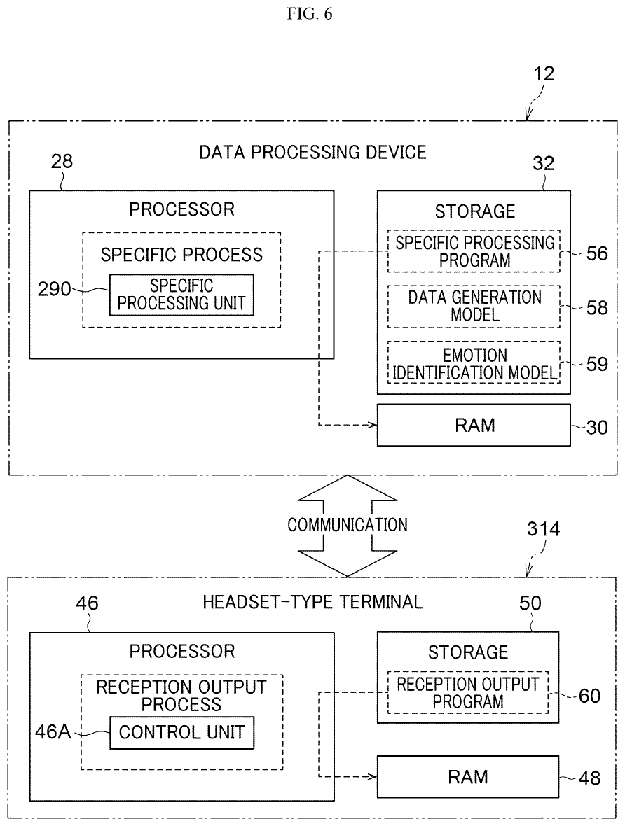

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

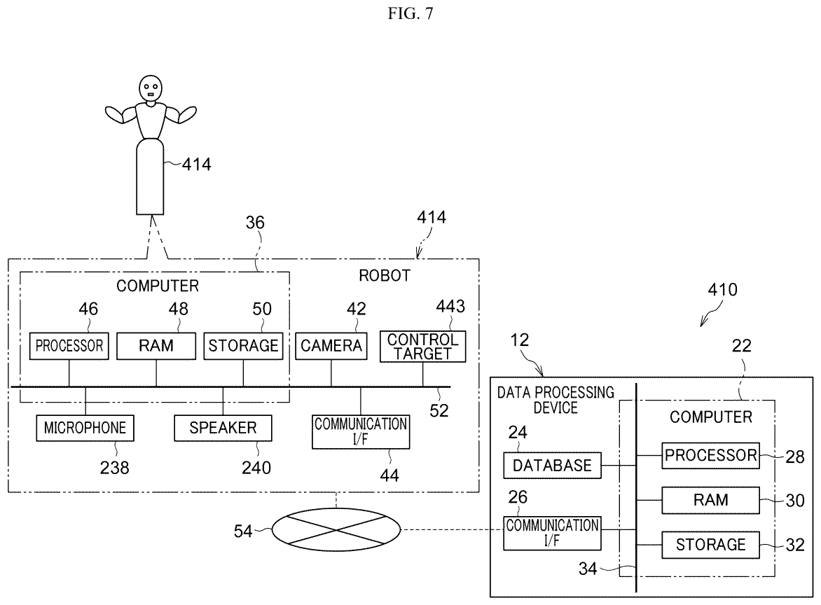

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

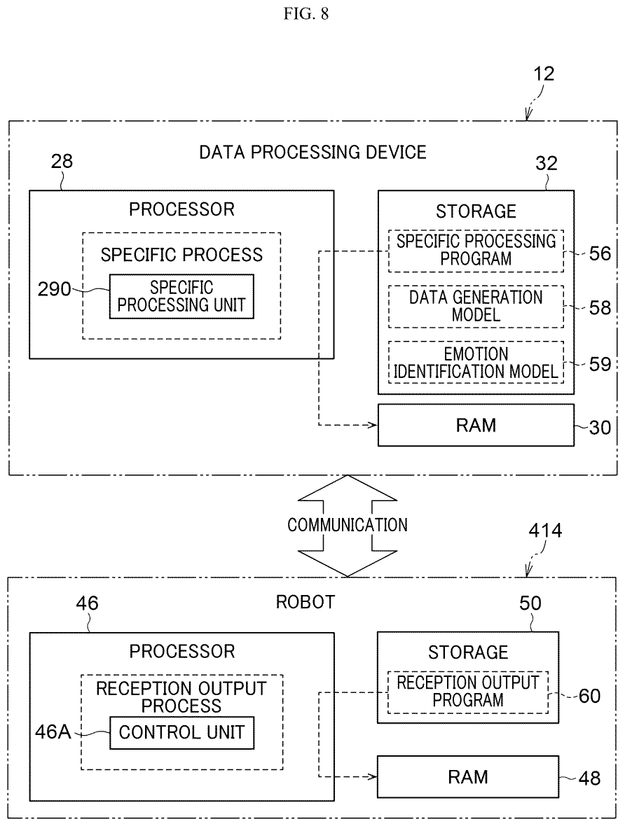

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

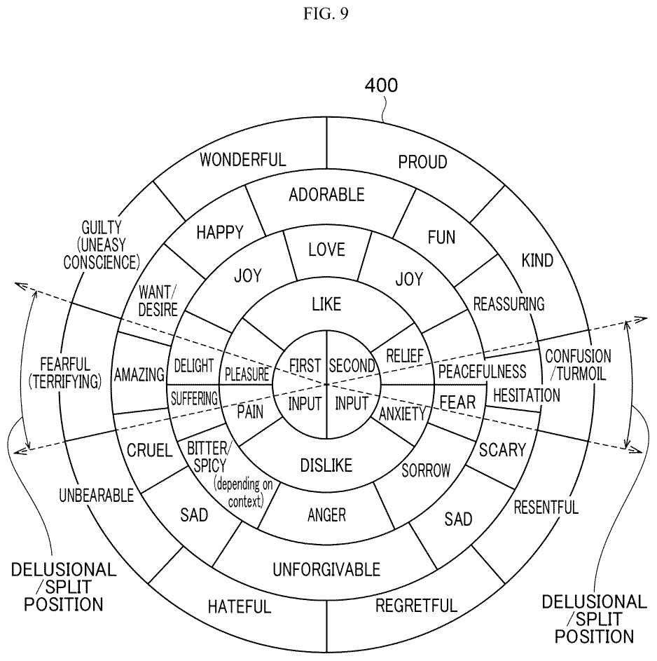

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

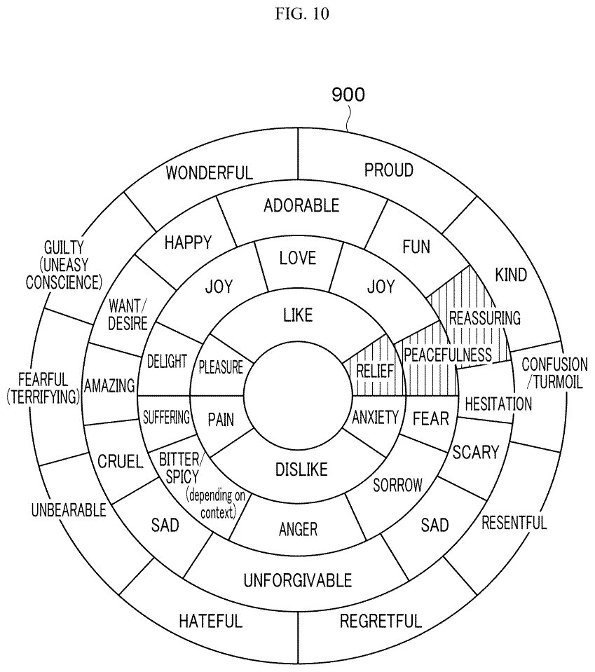

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, via a communication network and from a user operation apparatus, information including attribute information of a user and a keyword,
analyze the received information and convert the received information into a structured data format, and generate, on the basis of the structured data format, a prompt sentence including an instruction for generation to a generative information processing model,
generate a request message for transmitting the prompt sentence to the generative information processing model, and transmit the request message to the generative information processing model via the communication network,
receive, from the generative information processing model, response information generated on the basis of the prompt sentence,
format the received response information into display data that is displayable on the user operation apparatus by using a standardized description format and a dynamic display description format, and
transmit the display data to an information display apparatus.

### Supplementary 2

The system according to supplementary 1,
wherein the processor is configured to use, as the structured data format, a hierarchical data representation format, execute the analysis and conversion by a script execution environment operating on a general-purpose information processing apparatus, and generate the prompt sentence as a natural-language sentence in which the attribute information and the keyword are embedded.

### Supplementary 3

The system according to supplementary 1,
wherein the processor is configured to, in the formatting of the display data, arrange the response information in a document structure defined by the standardized description format, add a description of the dynamic display description format, and thereby enable the response information to be dynamically displayed on the information display apparatus of the user operation apparatus.

### Application Example 1

### Supplementary 1

A system comprising a processor,
wherein the processor is configured to
generate, for display on an information terminal, a screen that receives attribute information and free-description information from a user, and acquire the attribute information and the free-description information from the information terminal via a communication network,
perform information processing including natural language processing on the acquired attribute information and the acquired free-description information to identify an emotion of the user from the free-description information and to normalize the attribute information into category information indicating at least a generation, a gender, and an interest field of the user,
generate, on the basis of the identified emotion and the normalized attribute information, a prompt sentence including conditions regarding at least an output format, an amount of content, a writing style, and a structure, and construct instruction information that uses the prompt sentence as input to a generative AI model,
transmit the prompt sentence and the instruction information to the generative AI model,
cause the generative AI model to execute content generation processing to generate content for the user, and receive the generated content from the generative AI model,
perform post-processing on the generated content, the post-processing including at least formatting, structuring, and adding metadata, to generate display content converted into a display format corresponding to the attribute information of the user,
transmit the display content to the information terminal so that the display content is visually presented to the user by a display device of the information terminal, and
acquire a viewing history and an operation history of the user with respect to the display content, record a correspondence between the histories and the prompt sentence, and update generation conditions of a subsequent prompt sentence on the basis of the recorded correspondence.

### Supplementary 2

The system according to supplementary 1,
wherein the processor is configured to
statistically analyze a plurality of past prompt sentences and behavioral information including at least a viewing time, preference operations, and regeneration requests of the user with respect to content generated on the basis of the plurality of past prompt sentences, and automatically adjust at least part of the conditions regarding the output format, the amount of content, the writing style, and the structure in accordance with the behavioral information.

### Supplementary 3

The system according to supplementary 1,
wherein the processor is configured to
inspect the generated content with respect to predefined safety criteria or constraint conditions, in the post-processing, and when an expression violating the predefined safety criteria or the constraint conditions is detected, change at least one of content of the prompt sentence and generation conditions of the generative AI model, cause the generative AI model to execute content regeneration processing again, and transmit only regenerated content as the display content to the information terminal.

### Example 2

### Supplementary 1

A system comprising a processor,
wherein the processor is configured to
receive character information input by a user via a terminal through a communication network,
convert the received character information into structured information, analyze the structured information together with attribute information related to the user, and generate a prompt sentence for input to a generative AI model,
input the prompt sentence and the attribute information into the generative AI model operating on an information processing apparatus including a matrix computation device, and
cause the generative AI model to generate a response candidate including an expression corresponding to the attribute information of the user based on probabilistic computation,
select, from among a plurality of expressions included in the response candidate, an appropriate expression based on a predetermined selection condition, and generate a response text including the selected expression, and
encode the response text into a predetermined data format, transmit the encoded response text to the terminal, and output the encoded response text as response information to be displayed on a display device of the terminal.

### Supplementary 2

The system according to supplementary 1,
wherein the processor is configured to perform preprocessing for generating the prompt sentence, the preprocessing including dividing the character information into unit symbol sequences, converting the unit symbol sequences into an identifier sequence, generating model input data obtained by combining the identifier sequence and the attribute information of the user, and formatting the model input data into an input format for the generative AI model.

### Supplementary 3

The system according to supplementary 1,
wherein the processor is configured to cause the generative AI model to execute sequential probabilistic distribution computation on the model input data using the matrix computation device, and perform a candidate selection process based on a search algorithm on a plurality of candidate expressions obtained by the sequential probabilistic distribution computation, thereby generating the response candidate.

### Application Example 2

### Supplementary 1

A system comprising a processor,
wherein the processor is configured to
receive information obtained from a user terminal, via an input interface, as user information including text data and user attribute data,
extract the text data and the user attribute data from the received user information, and apply a natural language processing algorithm to the text data to identify an emotion of a user as emotion data,
integrate the emotion data with the user attribute data and behavior history data accumulated for the user to generate structured data,
dynamically construct, on a basis of the structured data, a generation input sentence by template processing, and generate a prompt sentence as an input for a generative AI model on a basis of the generation input sentence,
input the prompt sentence to the generative AI model, execute an inference process including matrix operations and attention operations in the generative AI model, and cause the generative AI model to generate response information including expression information corresponding to the emotion and the user attribute data,
select, on a basis of predefined evaluation rules and the emotion data, at least one phrase or sentence from a plurality of phrases or sentences included in the response information, and
generate personalized message information on a basis of a result of the selection,
format the personalized message information into display data, and transmit the display data to the user terminal via a communication network, and
store additional input or operation history transmitted from the user terminal as the behavior history data, and update the structured data used for generation of a subsequent prompt sentence and a subsequent personalized message information on a basis of the behavior history data.

### Cupplementary 2

The system according to supplementary 1,
wherein the processor is configured to format the personalized message information into a display data format including a structured markup document and script code, the structured markup document and the script code being configured to dynamically update a document structure of a user interface element on the user terminal, and to cause the user terminal to rewrite content of a document object and display the personalized message information in real time.

### Supplementary 3

The system according to supplementary 1,
wherein the processor is configured, in generating the prompt sentence, to select a prompt template corresponding to at least one use case among an advertising message generation use case, an encouragement message generation use case, a vocabulary selection message generation use case, and an information recommendation message generation use case, in accordance with a type of the emotion and the user attribute data, and to embed the structured data into the selected prompt template to generate a use-case-specific prompt sentence.

What is claimed is:

1. A system comprising:
circuitry configured to:
receive, via a communication interface coupled to a packet-switched network, input information from a terminal device, the input information including attribute information of a user and keyword data;
analyze the input information and convert the input information into structured data in a hierarchical data representation format;
generate, based on the structured data, a prompt sentence including an instruction for a generative neural network model, the prompt sentence embedding the attribute information and the keyword data;
transmit the prompt sentence to the generative neural network model via the communication interface and receive response information generated by the generative neural network model based on the prompt sentence;
format the response information into display data using at least one of a standardized description format and a dynamic display description format; and
transmit the display data to the terminal device via the communication interface.

2. The system according to claim 1, wherein the circuitry is configured to execute the analysis and conversion of the input information using a script execution environment on a general-purpose processing apparatus to generate the structured data as a hierarchical data representation.

3. The system according to claim 2, wherein the circuitry is configured to generate the prompt sentence as a natural language sentence in which the attribute information and the keyword data are embedded as named fields in the hierarchical data representation.

4. The system according to claim 3, wherein the circuitry is configured to include, in the prompt sentence, an instruction component specifying at least one of a response style, a content format, and an output length constraint derived from the attribute information.

5. The system according to claim 4, wherein the circuitry is configured to analyze the input information using a natural language processing model to identify an affective state of the user, and include the identified affective state as an additional constraint in the prompt sentence.

6. The system according to claim 5, wherein the circuitry is configured to adjust the instruction component of the prompt sentence based on the identified affective state to cause the generative neural network model to generate a response having a tone aligned with the affective state.

7. The system according to claim 1, wherein the circuitry is configured to format the display data by arranging the response information in a document structure defined by the standardized description format and adding dynamic display instructions to enable dynamic presentation on the terminal device.

8. The system according to claim 7, wherein the circuitry is configured to apply the dynamic display description format to add interactive display instructions to the display data, enabling the terminal device to present the response information with at least one of conditional rendering and event-driven layout updates.

9. The system according to claim 1, wherein the circuitry is configured to store the structured data, the prompt sentence, and the response information as record information in a storage device, and update generation conditions of subsequent prompt sentences based on the stored record information.

10. The system according to claim 9, wherein the circuitry is configured to analyze the record information to identify attribute patterns associated with high-quality response information, and adjust the instruction component of subsequent prompt sentences based on the identified patterns.

11. The system according to claim 1, wherein the circuitry is configured to generate the request message for the generative neural network model by encapsulating the prompt sentence in a protocol-compliant message format, and transmit the request message over the communication interface.

12. The system according to claim 11, wherein the circuitry is configured to parse the response information received from the generative neural network model to extract structured content fields, and map the extracted fields to display components in the display data.

13. The system according to claim 1, wherein the circuitry is configured to detect an affective state of the user from text data included in the input information using an affective recognition model, and modify the attribute information embedding in the prompt sentence to reflect the detected affective state.

14. The system according to claim 13, wherein the circuitry is configured to regenerate the prompt sentence with an updated affective state parameter when a subsequent input from the user indicates a changed affective state, to cause the generative neural network model to generate updated response information.

15. The system according to claim 1, wherein the circuitry is configured to receive a plurality of keyword data items from the terminal device, rank the keyword data items by relevance score derived from the attribute information, and embed the ranked keyword data items in the prompt sentence in ranked order.

16. The system according to claim 15, wherein the circuitry is configured to compute the relevance score by applying a scoring function to the attribute information and the keyword data items, and include only keyword data items having relevance scores exceeding a threshold value in the prompt sentence.

17. The system according to claim 1, wherein the circuitry is configured to retrieve, from a storage device, prior response information associated with similar attribute information and keyword data using a similarity search, and incorporate the retrieved prior response information as context data in the prompt sentence.

18. A system comprising:
circuitry configured to:
receive, via a communication interface coupled to a packet-switched network, input information from a terminal device, the input information including attribute information and keyword data, and analyze the input information to detect an affective state of the user using an affective recognition model;
convert the input information into structured data in a hierarchical data representation format, and generate a prompt sentence embedding the attribute information, the keyword data, and the detected affective state as constraint conditions;
transmit the prompt sentence to a generative neural network model via the communication interface and receive response information from the generative neural network model;
format the response information into display data by arranging the response information in a document structure defined by a standardized description format and adding dynamic display instructions defined by a dynamic display description format; and
transmit the display data to the terminal device via the communication interface, and store the structured data, the prompt sentence, and the response information as record information in a storage device for updating generation conditions of subsequent prompt sentences.

19. The system according to claim 18, wherein the circuitry is configured to rank keyword data items by relevance score derived from the attribute information, embed ranked keyword data items in the prompt sentence in ranked order, and include only keyword data items having relevance scores exceeding a threshold value.

20. A method comprising:
receiving, via a communication interface coupled to a packet-switched network, input information from a terminal device, the input information including attribute information of a user and keyword data;
analyzing the input information and converting the input information into structured data in a hierarchical data representation format;
generating, based on the structured data, a prompt sentence including an instruction for a generative neural network model, the prompt sentence embedding the attribute information and the keyword data;
transmitting the prompt sentence to the generative neural network model via the communication interface and receiving response information generated by the generative neural network model based on the prompt sentence;
formatting the response information into display data using at least one of a standardized description format and a dynamic display description format; and
transmitting the display data to the terminal device via the communication interface.
